(19) United States
(12) Patent Application Publication
(10) Pub. No.: US 2021/0073320 A1
(43) Pub. Date: Mar. 11, 2021

(54) VIDEO, AUDIO, AND HISTORICAL TREND DATA INTERPOLATION

(71) Applicant: Cham Ocondi, San Diego, CA (US)

(72) Inventor: Cham Ocondi, San Diego, CA (US)

(21) Appl. No.: 16/959,939

(22) PCT Filed: Jan. 3, 2019
(86) PCT No.: PCT/US2019/012227

§ 371 Date: Jul. 2, 2020

Related U.S. Application Data
(60) Provisional application No. 62/613,233, filed on Jan. 3, 2018.

(51) Int. Cl. G06F 17/17; G06F 17/18

(52) U.S. Cl. CPC G06F 17/17; G06F 17/18

(57) ABSTRACT

A method in a computer system expands an initial set of trend data values by generating an interpolating the initial set of trend data values. An input data stream of the initial set of trend data values is received. Each initial trend data value is divided into two extrapolated values. A first extrapolated value is less than its corresponding initial trend data value. A second extrapolated value is greater than its corresponding initial trend data value. A time period of each initial trend data value is divided in half. The first extrapolated value is associated with a first half of the time period. The second extrapolated value is associated with a second half of the time period. An output data stream is a series of the first and second extrapolated values each over half of the time period to create an expanded set of trend values.

### CROSS REFERENCE TO RELATED APPLICATIONS

This application is a national stage application under 35 U.S.C. 371 of International Application No. PCT/US2019/012227, filed 3 Jan. 2019, entitled “Video, Audio, and Historical Trend Data Interpolation,” which claims the benefit of priority pursuant to 35 U.S.C. § 119(e) of U.S. provisional application No. 62/613,233 filed 3 Jan. 2018 entitled “Video, audio, and historical trend data interpolation,” which is hereby incorporated herein by reference in its entirety.

### TECHNICAL FIELD

The technology described herein relates to techniques for data interpolation, compression, and decompression.

### BACKGROUND

When trend data are wirelessly exchanged between transmitting sources and receiving devices, the time domain of the data rate is a fixed number. For example, motion picture video is normally transmitted or broadcast at 30 frames per second. This rate is referred to by the television manufacturer as the refresh rate. Most television sets in the past had a picture refresh rate of 60 frames per second and would interlace between adjacent frames in order to translate the 30 frames into the 60 frames per second rate. State-of-the-art television sets are now offering a refresh rate of 240 frames per second to achieve better and smoother motion effects, particularly in slow motion mode.

Transformation from a 30-cycle to a 240-cycle picture frame rate requires insertion of eight interpolated picture frames to each picture frame received. The common insertion process used by the industry is accomplished by a simple process of Tangential Linear Extrapolation (TLE). This process is illustrated by FIG. 1. For right angle triangle A with rising hypotenuse 102 and a positive slope, tan(α)=(c-b)/0.33 assuming each data interval or bin has a time base of 0.33 seconds and the side 104 opposite angle α measures c-b. The data trend conversion ratio is equal to the time division of the time period of each data cell. The data bin value is determined by the multiplication of the time fraction and the tangential ratio of b and c.

A first data point 106a of the eight data points to be inserted along the hypotenuse of the right angle triangle A is={(c-b)/0.33}×(0.33/8)+b={(c-b)·⅛}+b. A second data point 106b={(c-b)· 2/8}+b. A third data point 106c={(c-b)·⅜}+b. A fourth data point 106d={(c-b)· 4/8}+b. A fifth data point 106e={(c-b)·⅝}+b. A sixth data point 106f={(c-b)· 6/8}+b. A seventh data point 106g={(c-b)·⅞}+b. An eighth data point 106g={(c-b)· 8/8}+b. The substitution of eight data points between the span of the two original data points results in a “decompression” ratio of 1 to 8 and extends the 30 picture frames per second to 240 picture frames per second.

FIG. 2 illustrates a trend profile on a data set using the TLE method to achieve data decompression with any compression ratio. Original trend data 202 is shown as a dot-dash line and the corresponding TLE profile 204 is shown as a solid line. It may be noted that the trend profile of the TLE conversion remains the same independent of the conversion factor or the compression ratio. While the TLE is an improvement over the step-ladder appearance of the original profile, it does not have the natural flow or look of a seamless analog trend. More importantly, the TLE process further filters the trend data that will flatten the peaks and fill the valleys, as it is similar to an averaging process of the trend data as depicted in FIG. 2.

In other data transmission environments, the data transmission rates may be limited and therefore typical data compression schemes are not functional. Only snapshots of data from particular time intervals may be collected, which may fail to reflect significant issues with equipment or environments being monitored. For example, in the oil and gas industry production data and well site analog data are normally transferred from Remote Terminal Units (RTU) at the wellheads to the central office host computer via a round-robin scan using a wireless full-duplex radio system. In addition to providing reports of well production and operating conditions, a user interface allows operators to request current production and operating data from the RTUs. It also allows the operators to download control strategies, as well as to send control commands to the RTUs. The host computer transmits these control strategies or commands to targeted RTUs by the same wireless radio system. The current radio system is only capable of 9,600 BAUD. In addition to the slow BAUD rate, radio key-up and key-down times further limit the amount of data transfer between the host computer and the wellhead RTUs.

As a result, in a common control system servicing several hundred RTUs, each RTU is scanned once an hour and only gas volume and its primary parameters of static pressure (P), differential pressure (DP), and temperature (T) are transmitted in these hourly reports. These hourly data of gas volume and parameters are presently considered acceptable audit-trail data by reporting agencies such as the American Gas Association (AGA), American Petroleum Institute (API), and Bureau of Land Management (BLM). Further production and analog data are reported and archived on a daily basis, that is, the accumulated volume per day or averaged value per day. However, averaged daily or hourly production data are not of analytical quality.

The average daily analog data and the accumulated daily production data of oil, gas, and water filter out the true characterization of both analog and production trends that are not at a constant value as represented by the averaged or accumulated daily data. Analog data, such as tubing, casing, line, and differential pressures can fluctuate from second to second depending on numerous operating activities of the production facilities at the wellhead. These facilities include separating vessels as well as artificial lift equipment such as a plunger lift, gas lift, and beam pumping unit. Oil, gas, and water production characteristics are highly sensitive to line pressure fluctuation caused by neighboring wells tied into lateral collection piping and compression systems. The separating vessel dumps oil and water intermittently while the plunger lift can cycle the well more than 18 times a day. Therefore, the daily averaged analog data and the daily accumulated production data and the hourly average of gas volume along with its primary parameters of P, DP, and T as reported by the RTUs do not provide analytical quality data that can be used to diagnose production and operation problems on a daily basis.

The information included in this Background section of the specification, including any references cited herein and any description or discussion thereof, is included for technical reference purposes only and is not to be regarded subject matter by which the scope of the invention as defined in the claims is to be bound.

### SUMMARY

A time domain expansion process is disclosed herein to recreate the trend profile that appears more natural and more closely matches the original trend profile, even in the absence of intervals of data. In addition to creating a seamless trend, peaks and valleys of the trend are restored, which significantly improves the quality of data for analysis or presentation. For example, in the context of video transmission and rendering, with the expansion process, an almost limitless number of picture frames can be created for interpolation at the receiver (e.g., television, set top box, computer) for display. The interpolated additional frames can improve the overall picture quality as well as the clarity in slow motion.

In one exemplary implementation, a method in a computer system for expanding an initial set of trend data values includes generating via a particularly configured microprocessor an expanded set of trend data values interpolating trend data values in the initial set of trend data values. An input data stream of the initial set of trend data values is received. Each initial trend data value of the initial set of trend data values is divided into two extrapolated values. A first extrapolated value is less than its corresponding initial trend data value. A second extrapolated value is greater than its corresponding initial trend data value. A time period of each initial trend data value is divided in half. The first extrapolated value is associated with a first half of the time period. The second extrapolated value is associated with a second half of the time period. An output data stream is output as a series of the first and second extrapolated values each over half of the time period in replacement of each corresponding initial trend data value to create the expanded set of trend values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is from the prior art and depicts a plot of a common TLE process for compression of data.

FIG. 2 is from the prior art and depicts a set of trend data and a trend conversion using TLE.

FIG. 3 depicts a first step in the conversion of trend data to create interpolated data according to a first exemplary implementation of the disclosed expansion process using a decompression ratio of 1:2.

FIG. 4 depicts a second step in the conversion of trend data to create interpolated data according to the first exemplary implementation of the expansion process.

FIG. 5 depicts a third step in the conversion of trend data to create interpolated data according to the first exemplary implementation of the expansion process.

FIG. 6 depicts a first step in the conversion of trend data to create interpolated data according to a second exemplary implementation of the expansion process using a decompression ratio of 1:3.

FIG. 7 depicts a second step in the conversion of trend data to create interpolated data according to the second exemplary implementation of the expansion process.

FIG. 8 depicts a first step in the conversion of trend data to create interpolated data according to a third exemplary implementation of the expansion process using a decompression ration of 1:5

FIG. 9 depicts a second step in the conversion of trend data to create interpolated data according to the third exemplary implementation of the expansion process.

FIG. 10 depicts a second step in the conversion of trend data to create interpolated data according to the third exemplary implementation of the expansion process.

FIG. 11 depicts an exemplary data trend.

FIG. 12 depicts a compression of the data trend of FIG. 11 by a compression ratio of 4:1.

FIG. 13 depicts a compression of the data trend of FIG. 12 by a compression ratio of 4:1.

FIG. 14 depicts a fourth exemplary implementation of the expansion process for the conversion of trend data to create interpolated data using a decompression ratio of 1:2.

FIG. 15 depicts the result of using the fourth exemplary implementation of the expansion process as shown in FIG. 14 on the compressed trend data depicted in FIG. 13.

FIG. 16 depicts the result of using the fourth exemplary implementation of the expansion process as shown in FIG. 14 on the compressed trend data depicted in FIG. 15.

FIG. 17 depicts the result of using the fourth exemplary implementation of the expansion process as shown in FIG. 14 on the compressed trend data depicted in FIG. 16.

FIG. 18 depicts the result of using the fourth exemplary implementation of the expansion process as shown in FIG. 14 on the compressed trend data depicted in FIG. 17.

FIG. 19 depicts the result of using the fourth exemplary implementation of the expansion process as shown in FIG. 14 on the compressed trend data depicted in FIG. 18.

FIG. 20 depicts the result of using the fourth exemplary implementation of the expansion process as shown in FIG. 14 on the compressed trend data depicted in FIG. 19.

FIG. 21 depicts the expanded trend data depicted in FIG. 20 in comparison with the initial compressed trend data depicted in FIG. 13.

FIG. 22 is a schematic diagram of an exemplary computer system configured for decompression or interpolation of trend data according to implementations of the expansion process disclosed herein.

FIG. 23 is a schematic diagram of an exemplary gas well configuration with remote data transmission.

FIG. 24 is a schematic diagram of an exemplary oil well configuration with remote data transmission.

FIG. 25 is a schematic diagram of an exemplary data relay and transmission system used in monitoring wellhead data in oil and gas production fields.

FIG. 26 is a graph plotting averaged trend data for several monitored wellhead parameters, wherein the averaged compression is chosen to produce an optimum data compression ratio and display quality down to a one-hour time scale.

FIG. 27 is a graph plotting averaged trend data for several monitored wellhead parameters including differential pressure indicating a zero shift transducer error.

FIG. 28 depicts a binary redistribution process for the conversion of trend data to create interpolated data.

FIGS. 29A-29B illustrate the conversion of one 3-minute data point to three 1-minute data points using the binary redistribution process.

FIGS. 30A-30D illustrate the three-step process of converting a series of 5-minute trend data to a series of 1-minute trend data.

FIG. 31 is a trend data plot with a ‘paint-brush’ effect when the time scale compresses the display of highly fluctuated trend data obscuring analytical quality.

FIGS. 32A-32I depict a first exemplary trend data interpolation process to remove the ‘paint-brush’ effect in a data display.

FIG. 33 A-32I depict a second exemplary trend data interpolation process to remove the ‘paint-brush’ effect in a data display.

FIG. 34 is a filtered trend data plot of FIG. 31 after iterative interpolation according to the methods of FIGS. 32A-33D.

FIG. 35 is a trend data chart showing the effects of improper sizing of the orifice plate on various measurement parameters.

FIG. 36 is a flow diagram of a control process for maintaining gas flow from a well head within measurable ranges.

FIG. 37 is a trend data plot showing flow results of a liquid-loaded well using a controller that fully opens the well with no flow control.

FIG. 38 is a trend data plot showing flow results of a liquid-loaded well using an intermittent controller with flow control according to the flow control process of FIG. 36.

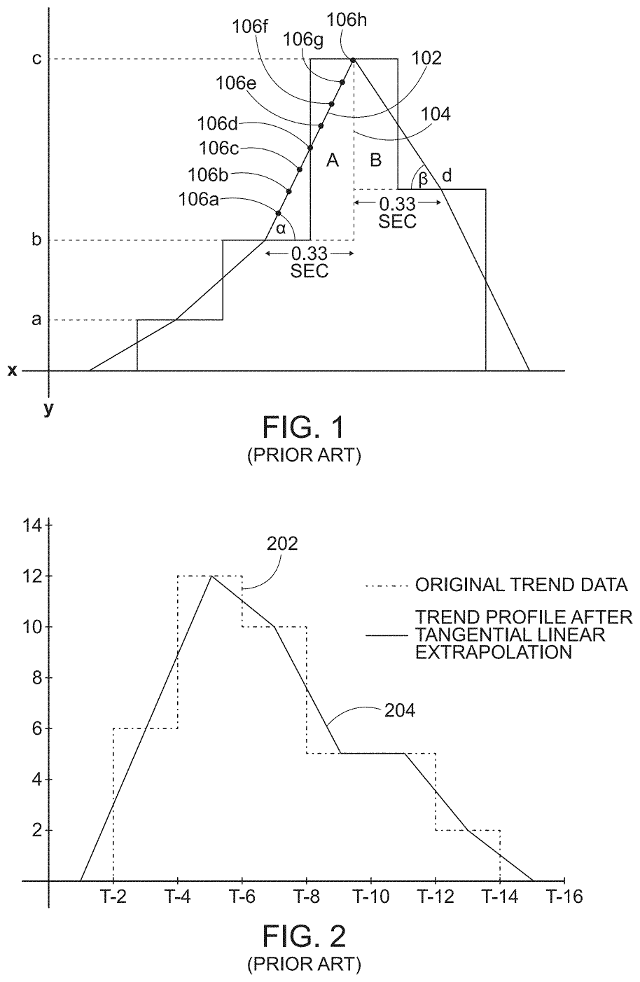

### DETAILED DESCRIPTION

A number of breakdowns or groupings of trend data time increments are possible according to the trend data expansion processes described herein in order to interpolate data or decompress previously compressed data by iterations of averaging adjacent time period trend values.

Iterative Decompression by Successive Factors of 2

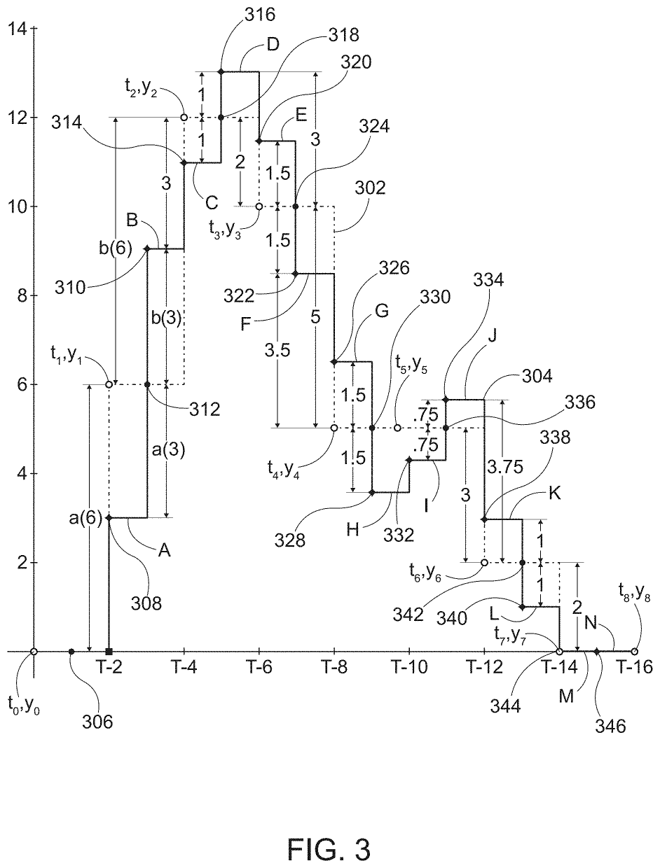

FIG. 3 is an exemplary plot showing the first step of a first exemplary implementation of a trend data expansion process for “decompressing” trend data. The dot-dashed line represents the original series of trend data 302. The data “points” (tₙ,yₙ) are constant for a period of time (2t) before the next sample occurs and are thus actually intervals or bins over the period. Therefore, the value of each data interval begins at the earliest time position of each horizontal line. The solid line represents a converted trend profile 304 after the trend data expansion process. To convert the original trend data 302, each of the trend data bins in the original data plot of FIG. 3 is divided into two extrapolated data bins, one of lesser value and one of greater value than the original data value. Both extrapolated data bins are equally spaced from the original data value, and the time period of each original data bin is cut in half. The first extrapolated data bin is positioned on the plot at the beginning of the period and extends for half the original period. The second extrapolated data bin is positioned at half the original period and extends half the original period to the end of the original period. The two extrapolated data bins may be a first step in an iterative process that may ultimately smooth the trend data and approach a slope, or an analog bridge, connecting each pair of neighboring extrapolated data bins.

The data shown in the plots in FIG. 3 is simplified for the purposes of illustration and merely depicts relationships between straightforward numeric values. However, the same concepts in the disclosed in the exemplary trend data expansion processes can be applied to transform complex datasets (e.g., a matrix of pixel values in a video frame) by making adjustments between corresponding values in each adjacent data set. As depicted in FIG. 3, the midpoint of each data interval across a time period is indicated by a circular bullet on the original dashed trend data plot line 302. Extrapolated data points at the start of each half period on either side of the midpoint are marked as diamonds on the solid converted data set line 304. Note that peaks and valleys begin to form after one iteration of the trend data expansion process.

As shown in FIG. 3, for the data bin starting at any point (tₙ,yₙ), a preceding value “a” is measured as the distance from the prior extrapolated data point and (tₙ₋₁, uₙ₋₁) and a trailing value is “b” is measured as the distance between the data point (tₙ,yₙ) and the following data point (tₙ₊₁, yₙ₊₁). (This is the typical case unless the y value of the following data point is the same as the y value of the data point to be adjusted. In such a case, the trailing value “b” is measured to the next change in y value in the original plot.) Adjustment of the values of each original data bin into two extrapolated data bins is then determined according to the following calculations. First, if a=b, the two extrapolated data bins are adjusted equidistant from the original data point (referred to herein as the “midpoint”) a value of:

(a+b)/4=a/2 or b/2 (since a and b are equivalent)

as shown in FIG. 3. Note, the denominator is 4 in this example, but can be greater or lesser depending upon the desired rate of change of the trend data expansion (i.e., the deviation from the initial bin value of each sample period). In this example, the initial period of each trend data value is 2t and the result is interpolated bins over a period of 1t.

If a>b, the deviation from the midpoint may be determined as follows:

a−(a+b)/2=(a−b)/2

The percentage deviation from the midpoint is thus

{(a−b)/2}/{(a+b)/2}=(a−b)/(a+b)

The adjusted value of the slope value from the midpoint may be represented as

(a−b)/(a+b)×(a+b)/4=(a−b)/4

The final adjustment value from the midpoint is determined as follows

(a+b)/4−(a−b)/4=2b/4 or b/2

If b>a, the above mathematical derivation will yield a similar adjustment result of a/2. Thus, if “a” is lesser in value than “b,” then the adjustment is half of “a.” Alternatively, if “b” is lesser in value than “a,” then the adjustment is half of “b.”

Returning to the example of FIG. 3, the first data bin on the original trend data line 302 starting at point (t₀,y₀) has a value of 0. Thus, a=0 (there being no distance and no prior extrapolated point) and b=6. As a<b, the value of adjustment of the data point (t₀,y₀) is 0/2=0, so no adjustment is made at the first midpoint identified at the circular bullet 306 between t₀ and t₁. The adjustment for the second data bin starting at point (t₁,y₁) is shown with the generic values of “a” (the vertical distance between the data point (t₁,y₁) and the prior extrapolated data point 306) and “b” (the distance between the data point (t₁,y₁) and the following data point (t₂,y₂)). In this case, a=6 and b=6. Thus, the adjustment value is a/2=b/2=6/2=3. The data bin starting at point (t₁,y₁) is thus split into a first extrapolated data bin A three units below y₁ at starting point 308 and extending for a period of 1t, and a second extrapolated data bin B adjusted to a point three units above y₁ beginning at point 310, which corresponds on the time axis to the midpoint 312 of the period of the data bin starting at point (t₁,y₁) on the original data trend line 302, and extending for a period of 1t.

Next, the data bin starting at point (t₂,y₂) on the original data trend line 302 is adjusted. The “a” value is the distance between the data point (t₂,y₂) and the prior extrapolated data point 310 and the “b” value is the distance between the data point (t₂,y₂) and the following data point (t₃,y₃). In this case, a=3 and b=2. Thus, the adjustment value is b/2=2/2=1. The data bin starting at point (t₂,y₂) is thus split into a first extrapolated data bin C one unit below y₂ starting at point 314 and extending for a period of 1t, and a second extrapolated data bin D adjusted to a point one unit above y₂ beginning at point 316, which corresponds on the time axis to the midpoint 318 of the period of the original data bin starting at point (t₂,y₂) on the original data trend line 302, and extending for a period of 1t.

Next, the data bin starting at point (t₃,y₃) on the original data trend line 302 is adjusted. The “a” value is the distance between the data point (t₃,y₃) and the prior extrapolated data point 316 and the “b” value is the distance between the data point (t₃,y₃) and the following data point (t₄,y₄). In this case, a=3 and b=5. Thus, a<b and the adjustment value is a/2=3/2=1.5. The data bin starting at point (t₃,y₃) is thus split into a first extrapolated data bin E 1.5 units above y₃ at starting point 320 and extending for a period of 1t, and a second extrapolated data bin F adjusted to a point 1.5 units below y₃ beginning at point 322, which corresponds on the time axis to the midpoint 330 of the period of the original data bin starting at point (t₃,y₃) on the original trend data line 302, and extending for a period of 1t.

Next, the data bin starting at point (t₄,y₄) on the original data trend line 302 is adjusted. The “a” value is the distance between the data point (t₄,y₄) and the prior extrapolated data point 322 and the “b” value is the distance between the data point (t₄,y₄) and the first following data point with a changed y value, i.e., data point (t₆,y₆). This is because there is no change in the y value between y₄ and y₅. In this case, a=3.5 and b=3. Thus, b<a and the adjustment value is b/2=3/2=1.5. The data bin starting at point (t₄,y₄) is thus split into a first extrapolated data bin G 1.5 units above y₄ beginning at point 326 and extending for a period of 1t, and a second extrapolated data bin H adjusted to a point 1.5 units below y₄ beginning at point 328, which corresponds on the time axis to the midpoint 330 of the period of the original data bin starting at point (t₄,y₄) on the original trend data line 302, and extending for a period of 1t.

Next, data point (t₅,y₅) on the original data trend line 302 is adjusted. The “a” value is the distance between the data point (t₅,y₅) and the prior extrapolated data point 328 and the “b” value is the distance between the data point (t₅,y₅) and the following data point (t₆,y₆). In this case, a=1.5 and b=3. Thus, a<b and the adjustment value is a/2=1.5/2=0.75. The data bin starting at point (t₅,y₅) is thus split into a first extrapolated data bin I 0.75 units below y₅ and extending for a period of 1t and a second extrapolated data bin J adjusted to a point 0.75 units above y₅ beginning at point 334, which corresponds on the time axis to the midpoint 336 of the period of the original data bin starting point (t₅,y₅) on the original trend data line 302, and extending for a period of 1t.

Next, data point (t₆,y₆) on the original data trend line 302 is adjusted. The “a” value is the distance between the data point (t₆,y₆) and the prior extrapolated data point 334 and the “b” value is the distance between the data point (t₆,y₆) and the following data point (t₇,y₇). In this case, a=3.75 and b=2. Thus, b<a and the adjustment value is b/2=2/2=1. The original data bin starting at point (t₆,y₆) is thus split into a first extrapolated data bin K one unit above y₆ beginning at point 338 and extending for a period of 1t, and a second extrapolated data bin L adjusted to a point one unit below y₆ beginning at point 340, which corresponds on the time axis to the midpoint 342 of the period of the data bin starting at point (t₆,y₆) on the original trend data line 302, and extending for a period of 1t.

Finally, the data bin starting at point (t₇,y₇) on the original data trend line 302 is adjusted. The “a” value is the distance between the data point (t₇,y₇) and the prior extrapolated data point 340 and the “b” value is the distance between the data point (t₇,y₇) and the following data point (t₈,y₈). In this case, a=1 and b=0. Thus, b<a and the adjustment value is b/2=0/2=0. Data point (t₇,y₇) can be understood as being “split” into a first extrapolated data bin M zero units above y₇ beginning at point 344 and extending for a period of 1t, and a second extrapolated data bin N zero units below y₇ beginning at point 346, which corresponds on the time axis to the midpoint of the period (which is the same as point 346) of the original data bin starting at point (t₇,y₇) on the original trend data line 302, and extending for a period of 1t. After applying the first exemplary trend data expansion process to the original trend data profile 302 (dashed line), a new trend data profile 304 (solid line) appears.

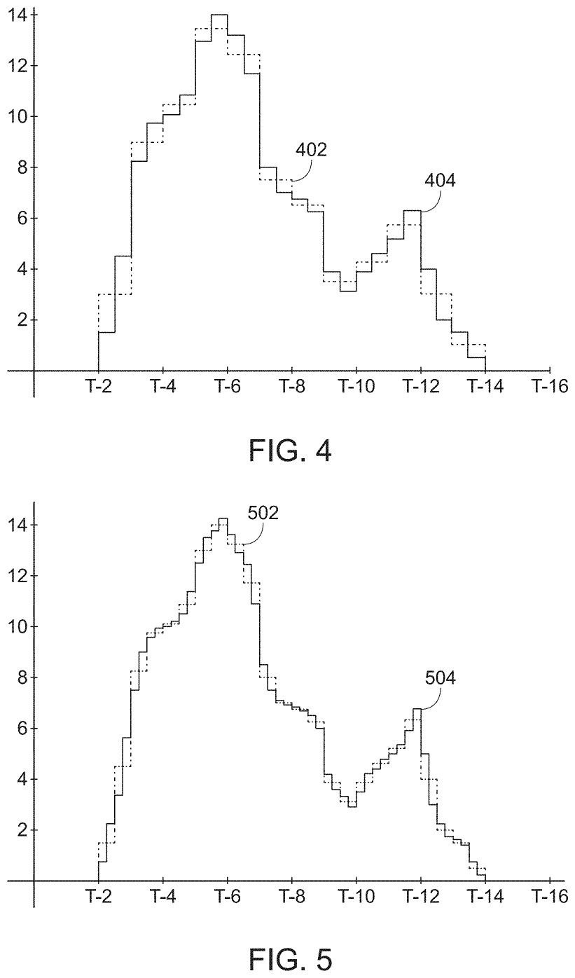

As shown in FIG. 4, the trend profile 402 (dashed line) is a result of the first trend data expansion process. It is subjected to a second trend data expansion process and the result is the new trend profile 404 (solid line). FIG. 5 depicts the trend profile 502 (dashed line) resulting from the second trend data expansion process of FIG.5. The trend profile 502 is now further subjected to a third trend data expansion process, which results in a new trend profile 504 (solid line). Note that peaks and valleys of the trend profiles are becoming more pronounced. After the third trend data expansion iteration, the “decompression” ratio for the original trend profile 302 (i.e., the dashed line in FIG. 3) achieved is 1 to 8 or 2³. The above three iterations of an trend data expansion transformation will effect “decompression” or, in this case where there are no actual frames between the original 30 frames per second, interpolation of additional frames to create 240 frames per second. Further, conversions according to the trend data expansion process will result in a more seamless analog trend profile as the period for each data point in the time domain is successively reduced by a factor of 2 and the adjustment between each data interval is further reduced by the same factor. A “decompression” ratio of 2n is effectively possible, with n being the number of times that the trend data expansion process is applied.

Decompression by Prime Compression Ratios (e.g., 3, 5, 7, etc.)

If a specific compression ratio is desired, for example a compression ratio of 60 to 1, a consecutive trend data expansion process with compression ratios of 2, 2, 3, 5 steps may be performed. The numbers 2, 2, 3, 5 are primary root multipliers of 60, or 2×2×3×5=60. Other compression/decompression and interpolation rations can be achieved by transforming odd interval periods into even periods and then performing the trend data expansion process. Further examples of these techniques follow.

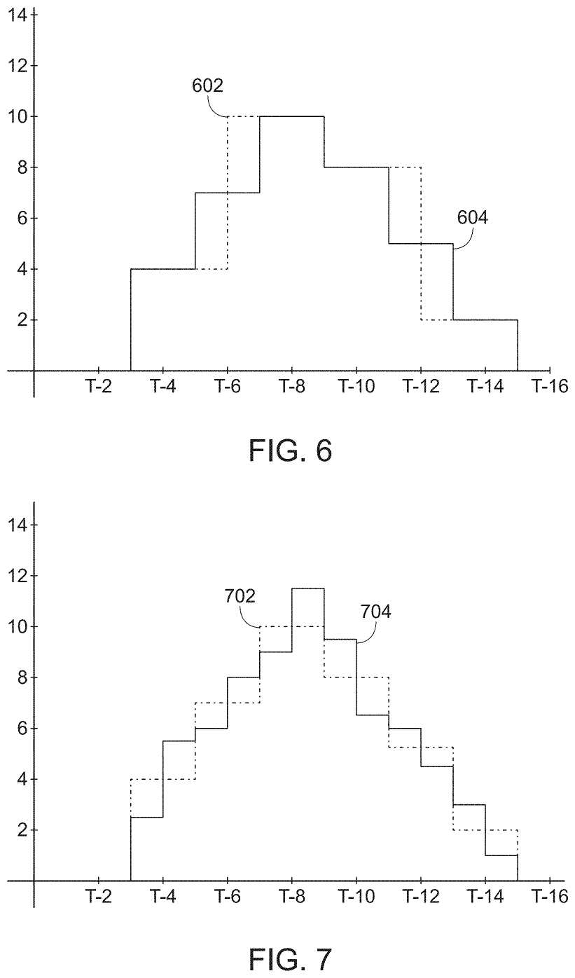

FIGS. 6 and 7 illustrate a two-step trend data expansion process decompression process or interpolation with time intervals or period divisions of 3 (i.e., a decompression ratio of 1 to 3). In FIG. 6, each data bin of the original trend plot 602 is divided into three equal numbers with a time period equal to one-third of its original time period. For example, FIG. 6 depicts a series of 3-time increment trend data with values of 0, 4, 10, 8, 2, 0 up to 18 time increments. These values can be expanded to a series of one-increment data bins as 0, 0, 0, 4, 4, 4, 10, 10, 10, 8, 8, 8, 2, 2, 2, 0, 0, 0. Next, in order to create a data set easily managed by the trend data expansion process, the average of adjacent pairs of one-increment data bins can be used to replace the values of the pairs. However, it may be desirable to only start pairing for a data set when the data bins are >0 to create a better fit with the original 3-time increment data. This option was chosen to produce the following series of one minute trend data pairs as represented by plot line 604 in FIG. 6: 0, 0, 0, 4, 4, 7, 7, 10, 10, 8, 8, 5, 5, 2, 2, 0, 0, 0. Multiple pairs of one-minute trend data with equal values thus result.

The standard trend data expansion process as shown in and described with respect to FIG. 3 can now be applied to the data bins as 2t time increment trend data to complete the time division of 3 as indicated in the plots of FIG. 7. The first two pairs of non-zero data are 4, 4, and7, 7. The net values of the pairs are 4 (4−0) and 3 (7−4). Half of the smaller of the two, 1.5, is applied to subtract from the first data bin of 4 and 1.5 is added to the second data bin of 4. Therefore, the first pair of one-minute data bins 4, 4, are transformed to 2.5 and 5.5 respectively. The remaining pairs of data bins are similarly transformed using the trend data expansion process to result in a final interpolated data set of 0, 0, 0, 2.5, 5.5, 6.25, 7.75, 8.75, 11.25, 9.5, 6.5, 5.75, 4.25, 3, 1, 0, 0, 0 as shown by the second trend plot 704 in FIG. 7.

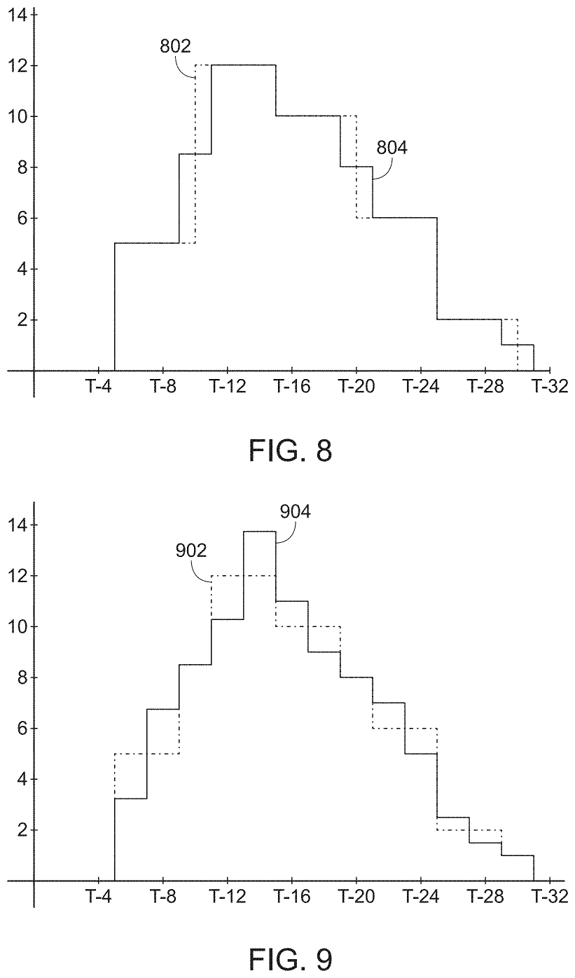

FIGS. 8-10 illustrate a three-step trend data decompression or interpolation process with time intervals or period divisions of 5 (i.e., a decompression ratio of 1 to 5). In FIG. 8, each data bin of the original trend plot 802 has a period of 5t and is divided into 5 equal periods of 1t, i.e., into time periods each equal to one-fifth of the original time period. For example, FIG. 8 depicts a series of 5t time increment trend data with values of 0, 5, 12, 10, 6, 2, 0. These values can be expanded into a series of 1t time increment data bins as 0, 0, 0, 0, 0, 5, 5, 5, 5, 5, 12, 12, 12, 12, 12, 10, 10, 10, 10, 10, 6, 6, 6, 6, 6, 2, 2, 2, 2, 2, 0, 0, 0, 0, 0. Next, in order to create a data set easily processed by the trend data expansion process, the value of the fifth data bin of a prior set may be averaged with the value of the first data bin of the next neighboring data set and the mean value used to replace the values of the pairs. However, it may be desirable to only start pairing for a data set when the data bins are >0 to create a better fit with the original 5t time increment data. This option was chosen to produce the following series of two minute trend data bins as represented by plot line 804 in FIG. 8: 0, 0, 5, 5, 8.5, 12, 12, 10, 10, 8, 6, 6, 2, 2, 1, 0, 0.

The standard trend data expansion process as shown in and described with respect to FIG. 3 can now be applied to the 4t time increment trend data bins as indicated in the first trend plot 902 of FIG. 9 (corresponding to derived trend data plot 804 in FIG. 8) to create two 2t time increment bins. Any 2t time increment bins created from the prior step are not transformed in this step, but may be used as starting or ending values for “a” and “b” in the trend data expansion process. The first non-zero 4t time increment data bin is 5 and the next bin value is 8.5. The net values of the “a” and “b” measures are 5 (5−0) and 3.5 (8.5−5). Half of the smaller of the two, 1.75, is subtracted from the first data bin of 5 and is added to the second data bin of 8.5. Therefore, the 4t time increment portion of the original 5t time increment is transformed into two 2t time increment bins of 3.25 and 6.75, respectively. The remaining 4t data bins are similarly transformed using the trend data expansion process, while the values of the 2t data bins derived from averages of adjacent last and first values of the original 5t bins remain unprocessed, to result in a final interpolated data set of 0, 0, 3.25, 6.75, 8.5, 10.25, 13.75, 11, 9, 8, 7, 5, 2.5, 1.5, 1, 0, 0 as shown by the second trend plot 904 in FIG. 9.

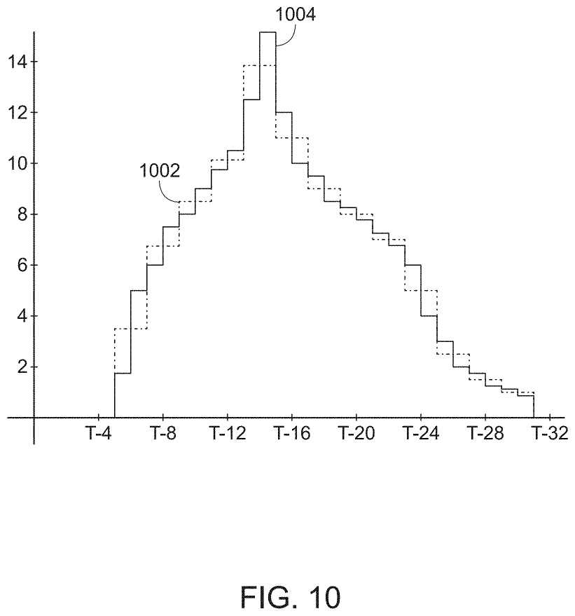

The trend data expansion process as shown in and described with respect to FIG. 3 is now further applied to the data pairs as 2t time increment trend data to complete the decompression factor of 5 as indicated in the plots of FIG. 10. The first trend plot 1002 of FIG. 10 corresponds to the interpolated trend data plot 904 in FIG. 9. The first two 2t time increment bins of non-zero data are 3.25, and 6.75. The net values of the pairs are 3.25 (3.25−0) and 3.5 (6.75−3.25). Half of the smaller of the two, 1.125, is subtracted from the first data bin of 3.25 and is added to the second data bin of 6.75. Therefore, a first set of 1t time increment data bins of 1.625 and 4.875 are created, respectively. The remaining pairs of data bins are similarly transformed using the trend data expansion process to result in a final interpolated data set of 0, 0, 0, 0, 1.625, 4.875, 5.875, 7.625, 8.3125, 8.6875, 9.46875, 11.03125, 12.375, 15.125, 12, 10, 9.5, 8.5, 8.25, 7.75, 7.375, 6.625, 5.8125, 4.1875, 3, 2, 1.75, 1.25, 1.125, 0.875, 0, 0, 0, 0 as shown by the second trend plot 1004 in FIG. 10.

Similar multiple steps of the trend data expansion process can be used to achieve decompression or interpolation with a 1-to-7 ratio. The first step is transformation of two data bins of 7t time increment periods into seven duplicated data bins each with a one-seventh time period. The bins can then be collected in different groupings, e.g., two groups of 7 bins can be arranged as two groups of 6t bins and a 2t bin (6, 6, 2), wherein the second grouping of 6t bins are accorded the average value of the last bin of the first group of 7 bins and the first bin of the second group of seven bins. The final 2t time increment bin remains at the original value of the second group of seven bins. The next step will result in a trend profile with bin periods of 3, 3, 3, 3, 2. The last time period conversion will result in seven pairs of equal value, or 2, 2, 2, 2, 2, 2, 2. Other breakdowns or groupings of trend data time increments are possible according to the trend data expansion processes described above in order to interpolate data or decompress previously compressed data by iterations of averaging adjacent time period trend values.

Iterative Decompression Using Constant Divisor Factor

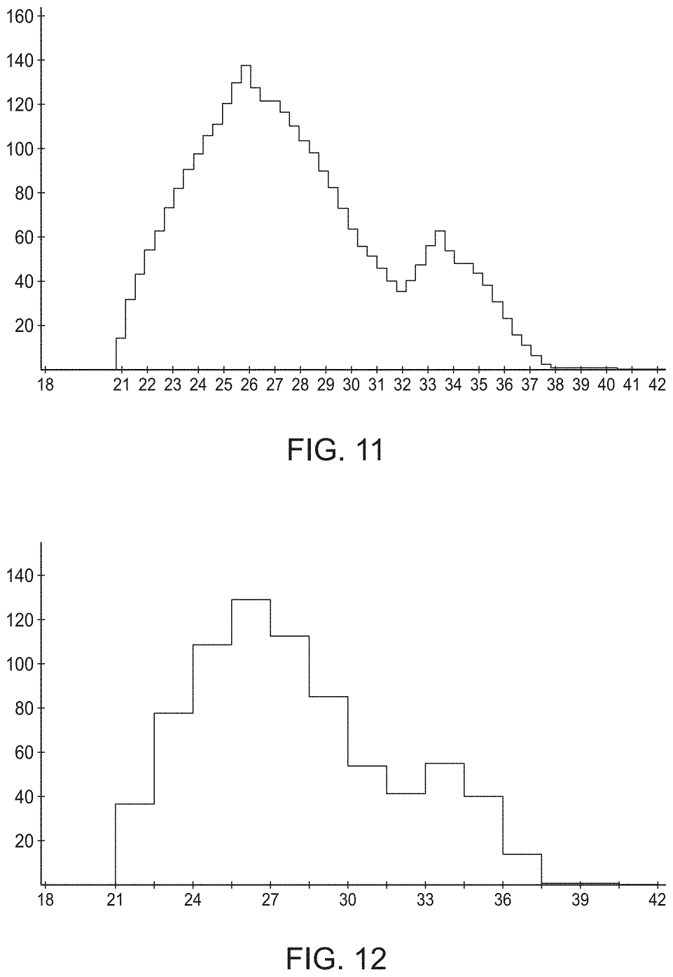

As noted above, other variants on the general trend data expansion process may be employed. For example, rather than the election method of FIG. 3, i.e., choosing between the larger of the a and b values on which to base the vartical or amplitude adjustment divisor, a static divisor value can be used regardless of the values of a and b. FIGS. 11-21 present a series of trend data graphics illustrating such an exemplary technique. For aid in understanding, the trend data of FIGS. 11-21 may be understood in the context of compression and decompression of video media to save memory space or otherwise reduce file size, which correspondingly reduces the required data transfer rate/bandwidth or air time in the broadcast and wireless transfer of video.

As an example, the intensity of each color (red, green, blue (RGB)) of each pixel on a television screen is a variable that changes in discrete values from frame to frame. FIG. 11 below is a given example of a trend pattern of a color intensity data variable for one color of a pixel across 48 frames. FIG. 12 depicts the trend pattern of FIG. 11 compressed by a factor of 4 by merely averaging every 4 data values of the trend data of FIG. 11. Note that the area under the curves of FIGS. 11 and 12 are the same. The trend data profile of FIG. 12 contains 12 data values rather than 48 and each data value has an assoicated time period of four times that of each data value of the trend data plot of FIG. 11. Note also that the peak point of the curve on the trend data plot of FIG. 12 is lower and the valley is higher than the corresponding peak and valley of the original trend data plot in FIG. 11.

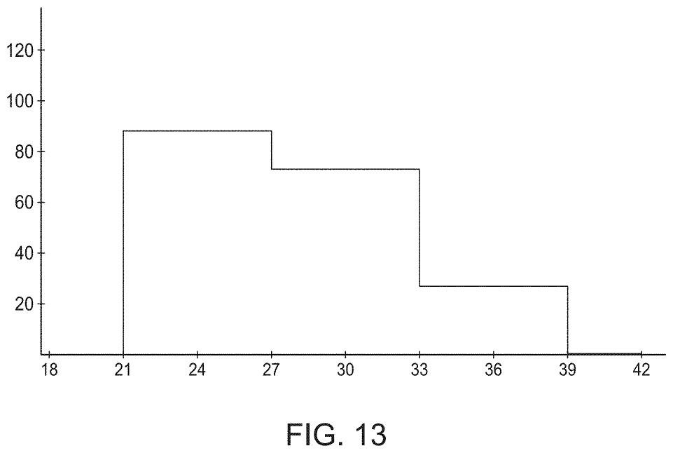

FIG. 13 depicts the trend pattern of FIG. 12 compressed again by a factor of 4 by averaging every 4 data values of the trend data of FIG. 12. Note that the area under the curves of FIG. 12 and FIG. 13 remain the same. The trend data plot of FIG. 13 contains only 3 data values and each data value has an associated time period 4 times that of each data value of the date trend values in FIGS. 12 and 16 times the time period for each data value of the trend plot of FIG. 11. Note also that the peak point of the curve on trend data plot of FIG. 13 is lower and its valley is higher than the corresponding peaks and valleys in FIG. 12. Through this simple averaging process, the original data values of he trend data of FIG. 11t are compressed by a factor of 16 in the trend data plot of FIG. 13.

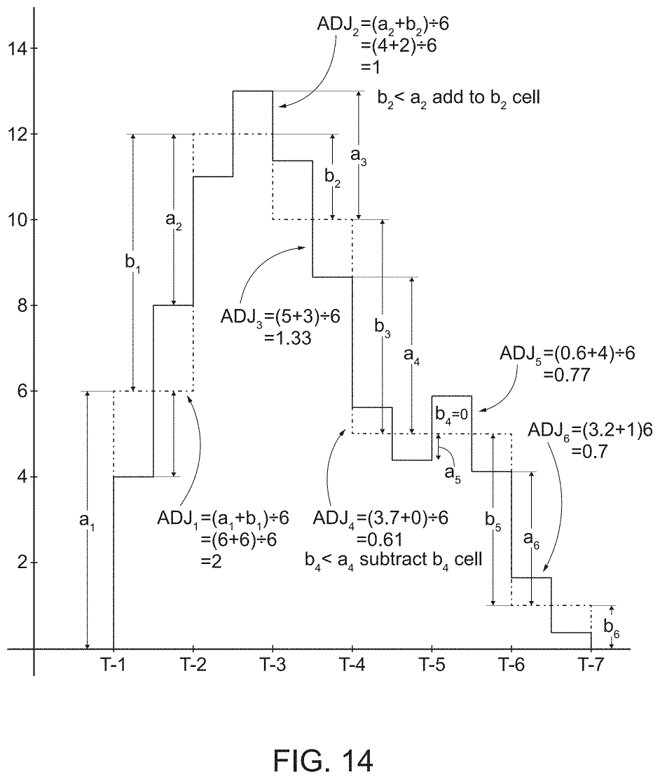

Trend data compressed in this manner can be decompressed or reversed to the original trend data pattern, i.e., trend data pattern of FIG. 13 can be reversed back to the trend data pattern of FIG. 11 using the trend data expansion processes disclosed herein. An exemplary variant of the trend data expansion process using the “binary” expansion concept disclosed herein is depicted in FIG. 14. Splitting of the “amplitude” or in this example case “intensity” trend data values is the primary factor in the trend data expansion process. In the embodiment of FIG. 14, rather than determining the larger of the differentials between adjacent data values as discussed with respect to FIG. 3, the differentials between the present data value (bin) and prior and later adjacent data values (i.e., an and bn as shown in FIG. 14) are merely summed and divided by 6, i.e., (a+b)/6. Note that “a” is the value of difference between the data value (bin) being split and the adjacent data value of the prior event after adjustment. In contrast, “b” is the value of the difference between the data value (bin) being split and the adjacent data value of the subsequent event before adjustment.

The time period of the data bin being expanded is halved and the quotient of (a+b)/6 is subtracted from the data value being expanded to provide the amplitude value for the first half of the split time period and the quotient of (a+b)/6 is added to the data value being expanded to provide the amplitude value for the second half of the split time period. Note that the values of a and b are directionally dependent on the slope of the trend data, i.e., if the trend data values are decreasing, the values of a and b will be negative such that the quotient of (a+b)/6 will be negative and by subtracting the quotient for the first half of the split time period, the data value of the first half will be greater than the data value for the second half, thus maintaining the proper downward slope of the trend data plot during expansion. Note that an adjustment where the next data value is 0, e.g., after cell 6 (a₆, b₆), resulting in a negative amplitude value for one of the first or second halves of the adjusted data bins, the algorithm will set a floor value of 0.

The trend data plot of FIG. 14 shows the transformation of 6 trend data points of (6, 12, 10, 5, 5, 1,) to 12 trend data points of (4, 8, 11, 13, 11.33, 8.67, 5.6, 4.4, 5.8, 4.2, 1.8, 0.3) using the algorithm (a+b)/6 to adjust the split data values. Note that the areas beneath the two plots are the same. The values in this algorithm provide a simple transition between data values (bins) and as the algorithm is iterated on a data trend. It can also function as a smoothing algorithm as disclosed further below.

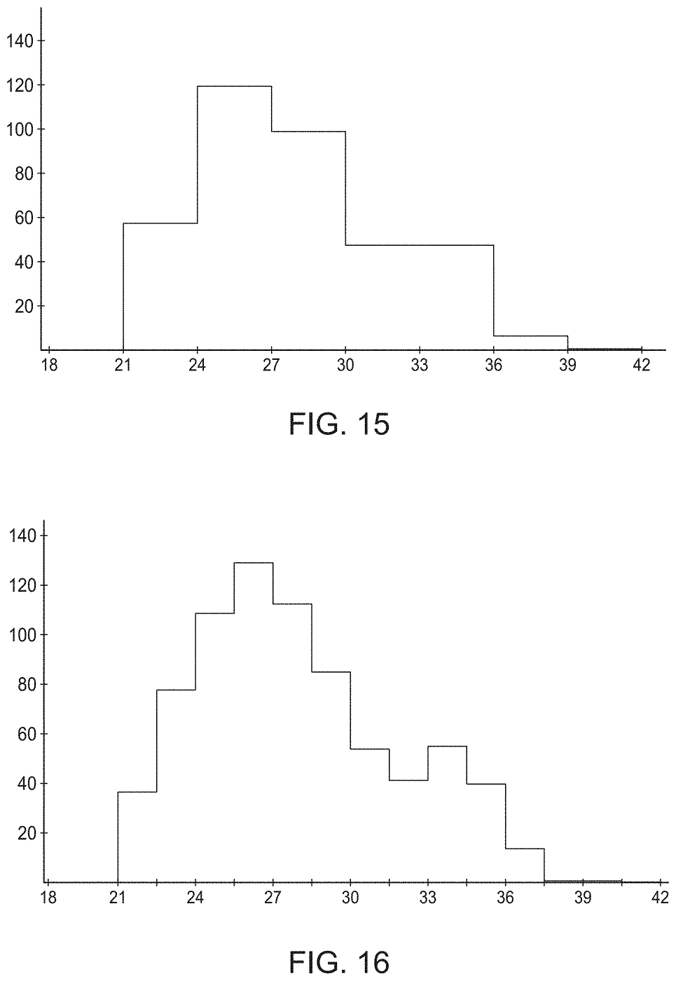

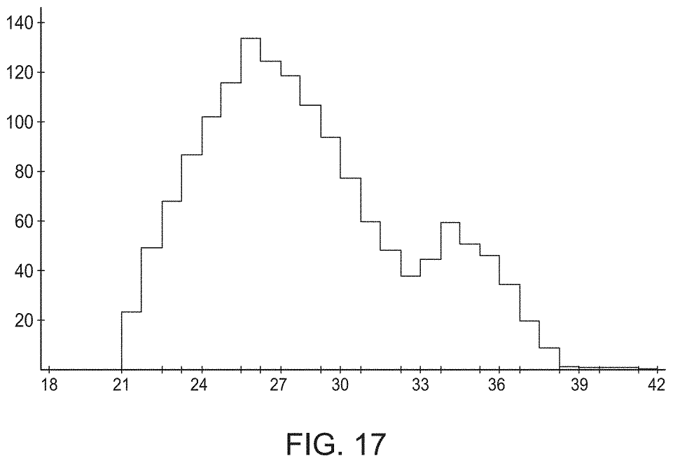

FIG. 15 depicts a first iteration of the trend data expansion process of FIG. 14 as applied to the compressed data trend profile of FIG. 13. The data trend profile of FIG. 15 shows the transformation of the 3 trend data values of FIG. 13 with periods of 6t into 6 trend data values with periods of 3t. FIG. 16 is second iteration of the trend data expansion process of FIG. 14 as applied to the compressed data trend profile of FIG. 15. The data trend profile of FIG. 16 shows the transformation of the 6 trend data values of FIG. 15 with periods of 3t into 12 trend data values with periods of 1.5t. FIG. 17 is a third iteration of the trend data expansion process of FIG. 14 as applied to the compressed data trend profile of FIG. 16. The data trend profile of FIG. 17 shows the transformation of the 12 trend data values of FIG. 16 with periods of 1.5t into 24 trend data values with periods of 0.75t.

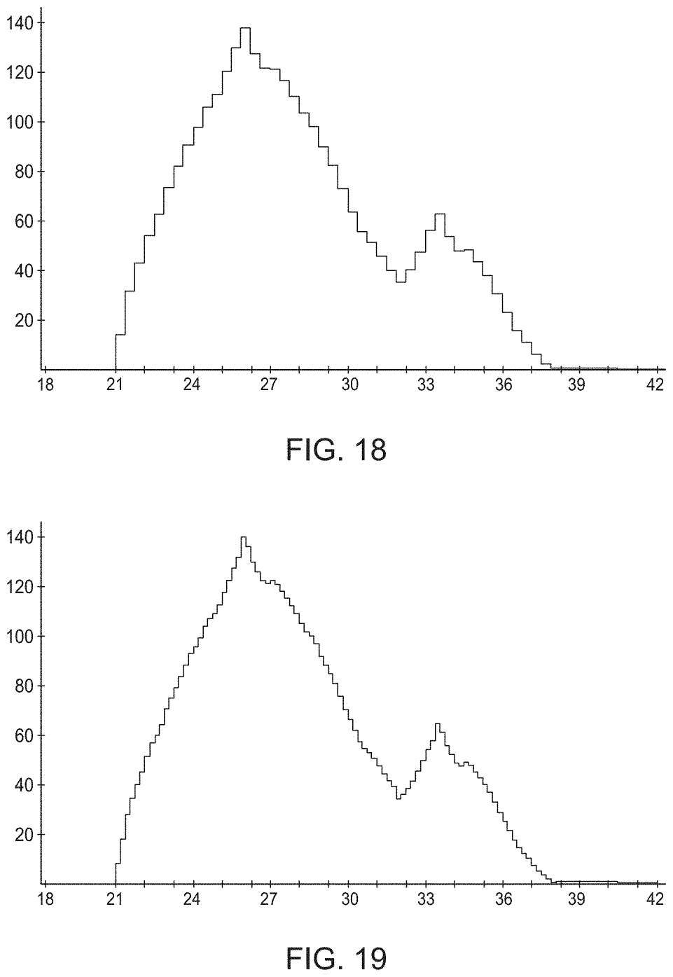

FIG. 18 is a fourth iteration of the trend data expansion process of FIG. 14 as applied to the compressed data trend profile of FIG. 17. The data trend profile of FIG. 18 shows the transformation of the 24 trend data values of FIG. 17 with periods of 0.75t into 48 trend data values with periods of 0.375t. Note that the trend data plot of FIG. 18 is the same as the original trend data pattern of FIG. 11. The trend data expansion process of FIG. 14 thus transforms the 3 data values of the compressed trend data pattern of FIG. 13 back to the original 48 data points of trend pattern of FIG. 11. Note, the original averaging (compression) of the data values was implemented by successive factors of 4, so the binary trend data expansion process of FIG. 14, i.e., expansion by a factor of during each iteration, takes twice the number of processes to return to the original data trend values. However, with the significant number of cycles per second of present computing power, large numbers of calculations per second can easily be made to effect trend data compression and decompression according to the processes described herein.

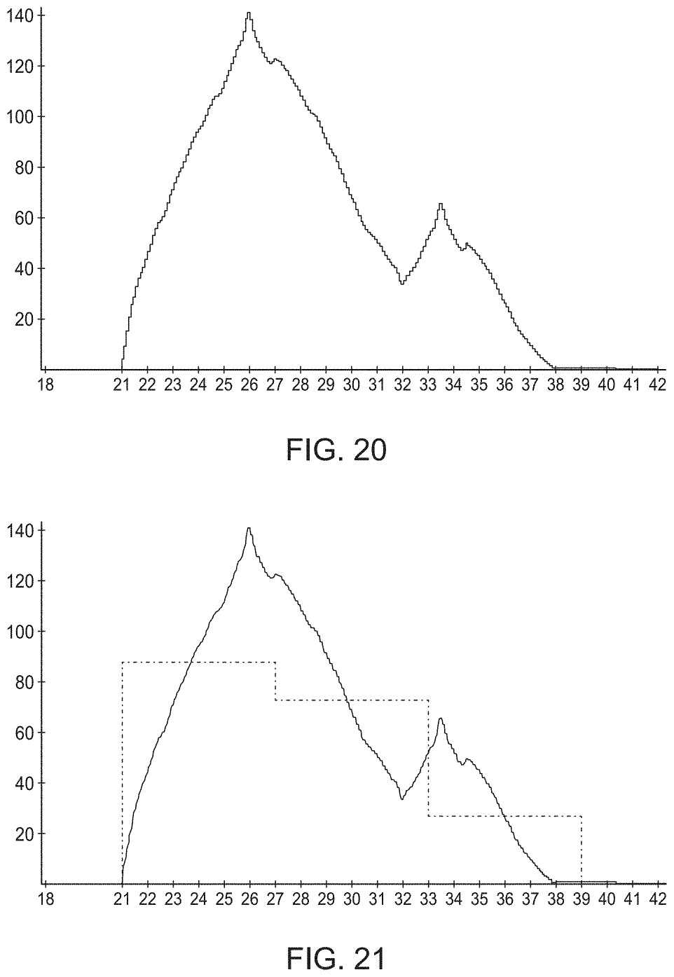

FIG. 19 depicts a continuation of the trend data expansion process which transforms the trend data pattern of FIG. 18 into the trend data pattern of FIG. 19 with 96 data values (i.e., twice the number of data points in FIG. 18) and each time period for a data value is half of time period of the data points in FIG. 18. By continuing the trend data expansion process, interpolation of additional data values is rendered and a data smoothing algorithm is thereby implemented. FIG. 20 is a continuation of the trend data expansion process which transforms the trend pattern of FIG. 19 into the trend data pattern of FIG. 20 with 192 data points (twice the number of data points in FIG. 19) and each time period for a data point is half of time period of the data points in FIG. 19.

FIG. 21 is a continuation of the trend data expansion process which transforms the trend pattern of FIG. 20 into the trend pattern of FIG. 21 with 384 data points (twice the number of data points in FIG. 20) and each time period for a data point is half of time period of the data points in FIG. 20. The trend data pattern of FIG. 21 goes beyond decompression from the compressed 3 data values of FIG. 13 (shown as a dashed line in FIG. 21) to a smoothed data set of 384 data points approaching an analog signal and results in a “decompression” ratio of 1 to 128.

Most video camera has shutter speed of 30 frames per second. Per the above simple averaging compression technique for pixel intensity values, the 30 frames per second can be compressed to 2 frames per second, for example, by averaging every 15 data points of every color pixel recorded (or by some smaller iterative factor). Presuming that color intensity of pixels does not vary greatly over half second increments, this will result in a compression ratio of 15 to 1. By this process, a 2 hour movie with 4 GB data is now reduced to 267 MB, i.e., a factor of 15, and the movie can be streamed using 1/15 of the bandwidth and further offers a significant reduction of memory storage. To display the video, the trend pattern expansion process will transform the 2 picture frames per second back to 30 frames per second.

In addition, after decompressing the 2 frames per second back to the original 30 frames per second, the trend pattern expansion process can be extended to interpolate 60, 120, 240, 480, frames per second. These interpolated frames will support televisions with high speed refresh rates to produce smoother motion and eliminate motion blurs. Further, seamless slow motion can be achieved by refreshing the decompressed data trend at the normal display speed. For example if slow motion by a factor of 2 is desired, the data trend from the interpolated 60 frames per second can be presented at 30 frames per second.

Also, seamless fast forward motion can be achieved by refreshing the compressed data trend at the normal refreshing speed of 30 frames per second. If a fast forward of twice the normal speed is desired, the data trend from the compressed 15 frames per second can be presented at 30 frames per second, i.e., two sets of 15 compressed frames presented within one second.

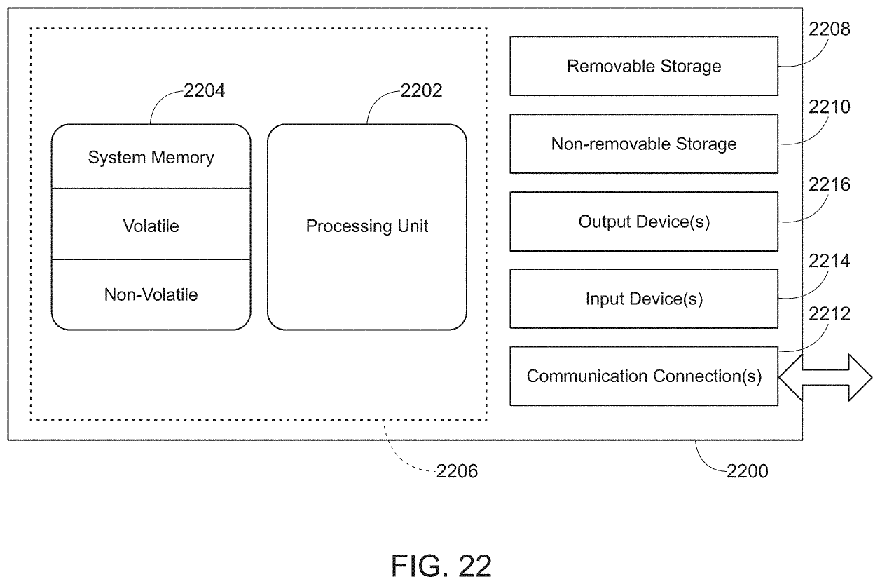

FIG. 22 illustrates an exemplary computer system or other processing device 2200 configured to perform the exemplary trend data expansion processes as described herein. In one implementation, the processing device 2200 typically includes at least one processing unit 2202 and memory 2204. Depending upon the exact configuration and type of the processing device 2200, the memory 2204 may be volatile (e.g., RAM), non-volatile (e.g., ROM and flash memory), or some combination of both. The most basic configuration of the processing device 2200 need include only the processing unit 2202 and the memory 2204 as indicated by the dashed line 2206.

The processing device 2200 may further include additional devices for memory storage or retrieval. These devices may be removable storage devices 2208 or non-removable storage devices 2210, for example, magnetic disk drives, magnetic tape drives, solid state drives, and optical drives for memory storage and retrieval on magnetic and optical media. Storage media may include volatile and nonvolatile media, both removable and non-removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the processing unit 2202. Additional instructions, e.g., in the form of software, may interact with the base operating system to create a special purpose processing device 2200. In implementations described in this application, instructions for implementing the trend data expansion process may be stored in the memory 2204 or on the storage devices 2210. Depending upon the nature of the trend data, the trend data expansion process may be implemented in a number of particularized forms to process the original data, for example, a form specific to processing video data vs. well head logging data. Any method or technology for storage of data, for example, computer readable instructions, data structures, and program modules, may be used in combination to implement the trend data expansion process on a computing device.

The processing device 2200 may also have one or more communication interfaces 2212 that allow the processing device 2200 to communicate with other devices. The communication interface 2212 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 2212 over the network via a modulated data signal, e.g., a carrier wave or other transport medium. A modulated data signal is an electromagnetic signal with characteristics that can be set or changed in such a manner as to encode data within the signal.

The processing device 2200 may further have a variety of input devices 2214 and output devices 2216. Exemplary input devices 2214 may include a keyboard, a mouse, a tablet, and/or a touch screen device. Exemplary output devices 2216 may include a video display, audio speakers, and/or a printer. Such input devices 2214 and output devices 2216 may be integrated with the processing device 2200 or they may be connected to the processing device 2200 via wires or wirelessly, e.g., via IEEE 802.22 or Bluetooth protocol. These integrated or peripheral input and output devices are generally well known and are not further discussed herein. Other functions, for example, handling network communication transactions, may be performed by the operating system in the nonvolatile memory 2204 of the processing device 2200.

Well Data Logging Application

A state-of-the-art wellhead Supervisory Control And Data Acquisition (SCADA) system, or as commonly known in the oil and gas industry a Remote Terminal Unit (RTU), is widely used for production measurement of oil, gas, and water at the well site. It can instantaneously read analog data such as tubing pressure, casing pressure, valve positions, and tank level. It is also capable of production control or the control of production equipment such as a well beam pumping unit or other liquid lift equipment, which includes gas lift, plunger lift, and submersible pump.

Production of oil, gas, and water is normally measured at the well site. Oil, gas, and water are separated by a three-phase separator before being measured. Gas is further dried by a dehydrator unit and is measured by a primary orifice meter that generates static pressure (P) and differential pressure (DP) from gas flow. A temperature probe is also installed along with the orifice meter to provide the third primary parameter, temperature (T). Secondary devices (P, DP, and T transducers) are installed so that the three basic parameters P, DP, and T are converted into electrical analog signals. Gas flow volume is calculated by an onsite, tertiary Electronic Flow Measurement (EFM) device. The EFM is a part of the RTU's function.

It is well recognized in the oil and gas industry that the hourly averaged data of the basic gas parameters of P, DP, and T that have been accepted by the American Gas Association (AGA), the American Petroleum Institute (API), and the Bureau of Land Management (BLM) as standard for audit trail are actually irreconcilable. The re-integrated or re-calculated results of the averaged hourly data of the primary parameters P, DP, and T as reported by an offsite EFM have been proven to have an error of 3 percent to more than 30 percent when compared to the calculated results of the onsite EFM that provides the hourly average of P, DP, and T as audit trail.

As required by the AGA, API, and BLM, the gas volume (Q) is calculated every second according to the following AGA-based formula,

Q=C′\sqrt{P×DP},

where

Q=volume in CFH (cubic feet per hour);

C′=a correction factor, determined mainly by the ratio of the orifice size, pipe diameter, P, DP, T, gas properties, and compressibility factor;

P=static pressure; and

DP=differential pressure across the orifice plate

The one-second calculated gas volumes are accumulated for hourly custody transfer reports and further accumulated for daily production reports. P, DP, and T, are scanned every second and are averaged into hourly and daily reports as part of the above-calculated gas volume reports. The hourly reports of Q, and the primary parameters of P, DP, and T, are required by AGA, API, and BLM for an audit trail, as they are considered to be custody transfer data.

Liquid measurement of the produced oil and water downstream from the separator is usually accomplished with turbine or positive displacement (PD) meters. Because the separated oil production is normally contaminated with water, a basic sediment and water (BS&W) probe, or the more accurate coriolis meter, is used to compensate for the contaminated water in the oil stream.

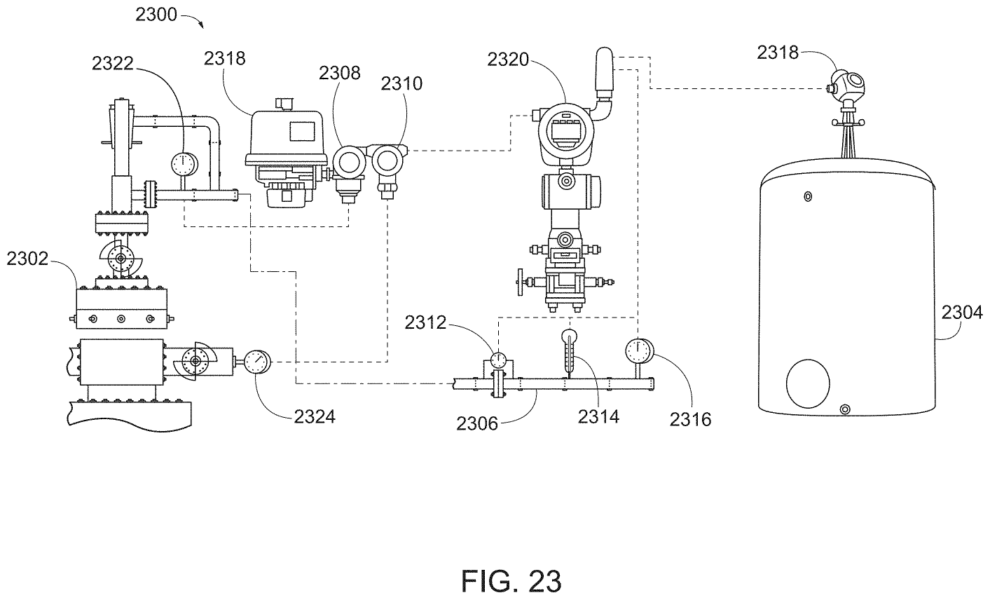

The majority of gas wells configurations 2300, for example, as shown in FIG. 23, produce a very small amount of liquid. Periodic weekly or monthly tank gauging is common practice by most gas producers to report daily oil or condensate and water production. FIG. 23 shows the RTU/EFM 2320 in communication with either wired or wireless analog transducers TP 2310, CP 2308 at the flow choke controller 2318 on the wellhead 2302, transducers DP 2312, T 2314, and P 2316 on the gas piping 2306, and water tank level transducer (2318). This connectivity allows the RTU/EFM 2320 to sample all the analog transducers at least once per second. RTU/EFM 2320 is a programmable device with I/O interface, memory, and mathematical functions to affect measurement, control, data acquisition, and data communication with various end-devices, control systems, and remote PCs.

In the same embodiment, RTU/EFM 2320 is also in serial data communication with a motorized variable choke controller 2318. The serial data communication between the RTU/EFM 2320 and the choke controller 2318 allows the RTU/EFM 2320 to download choke positions and interrogate the operating conditions of the choke controller 2318.

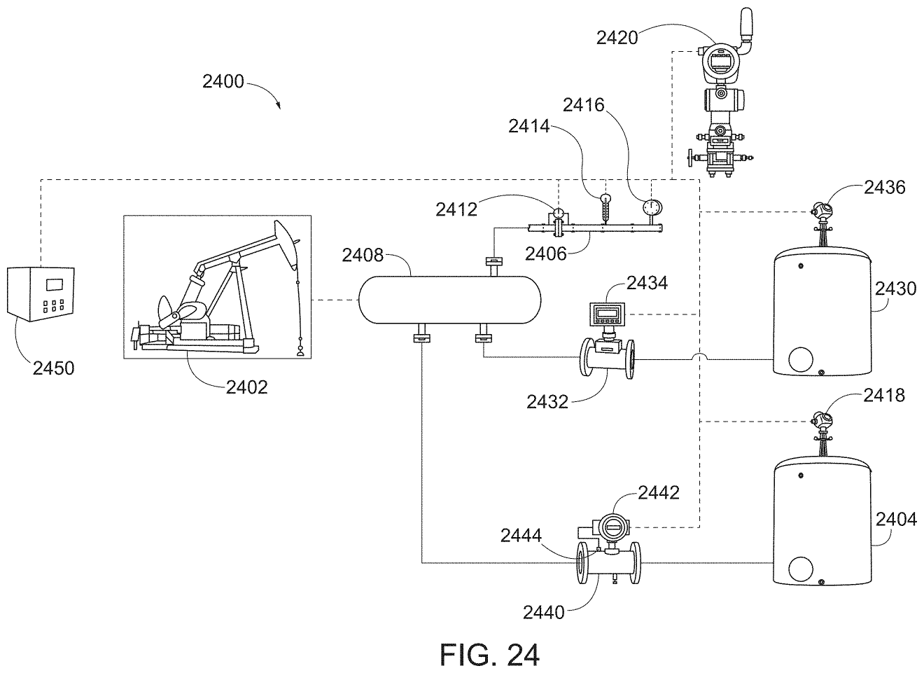

FIG. 24 depicts an oil pumping configuration 2400 with an RTU/EFM 2420 in communication with DP 2412, T 2414, P 2416 transducers, a water tank level transducer 2436 on the water tank 2430, oil tank level transducer 2418 on the oil tank 2404, a water meter 2434 on a water turbine 2432 connected between the separator 2408 and the water tank 2430, an oil meter 2442, and a basic sediment and water (BS&W) probe 2444 on an oil turbine 2440 connected between the separator 2408 and the oil tank 2404. The combination of oil meter 2442 and the BS&W probe 2444 allows the RTU/EFM 2420 to calculate the net amount of oil and water production from the well 2402 equipped with a beam-pump unit as liquid lift. In lieu of the oil meter 2442 and BS&W probe 2444, a more accurate coriolis meter may be installed to produce the net volume of oil and the amount of water mixed in with the oil. In the same embodiment, the RTU/EFM 2420 is in serial-data communication with a pump-off controller 2450, allowing the RTU/EFM 2420 to record “dynamo meter” cards and read pumping unit operating conditions from the pump-off controller 2450.

The RTU/EFM 2320, 2420 is programmed to operate as a data logger scans data from all analog transducers every second. It also calculates gas volume and accumulates net oil and water production in one-second increments. The one-second data are stored in temporary files of the RTU/EFM 2320, 2420. After 90 seconds, the 90 one-second data points will be averaged into one-and-one-half-minute data points and stored for 35 days in a circular queue fashion. The 90-second or 1.5-minute average is chosen to produce an optimum data compression ratio and display quality down to a one-hour time scale as shown in FIG. 26

The first objective is to provide detailed analytical quality trending data with one-second resolution of production and analog data. The RTU is programmed as a data logger to scan the analog data and calculate gas, oil, and water production every second and average into a 90-second or 1.5 minute data file. In this case, the 1.5 minute averaged data file is chosen to affect analytical quality plotting that is plotted on a one-hour time period. This will display analytical quality trend for an intermittent liquid-loaded gas well with up to 24 cycles per day. The fastest intermittent cycle well has been observed to be about 18 cycles per day. The 1.5 minutes averaged trending file will also affect optimum data compression ratio. If a higher trend resolution is needed (i.e., less than one-hour time scale of trend display), the averaged data file can be refined to less than one minute with minor effect on the data compression ratio. The averaged-minute data file is saved for 35 days or longer in a circular queue manner.

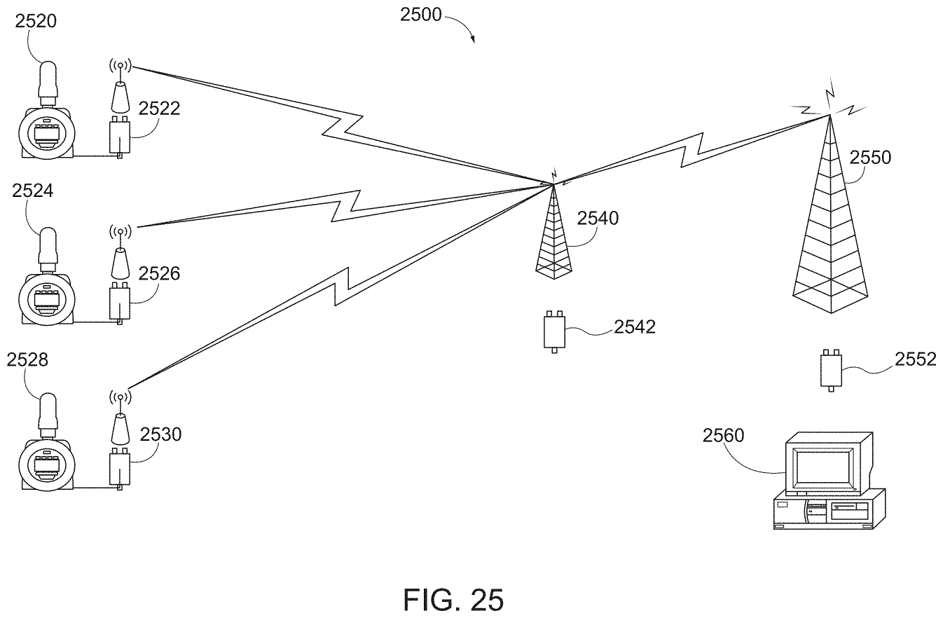

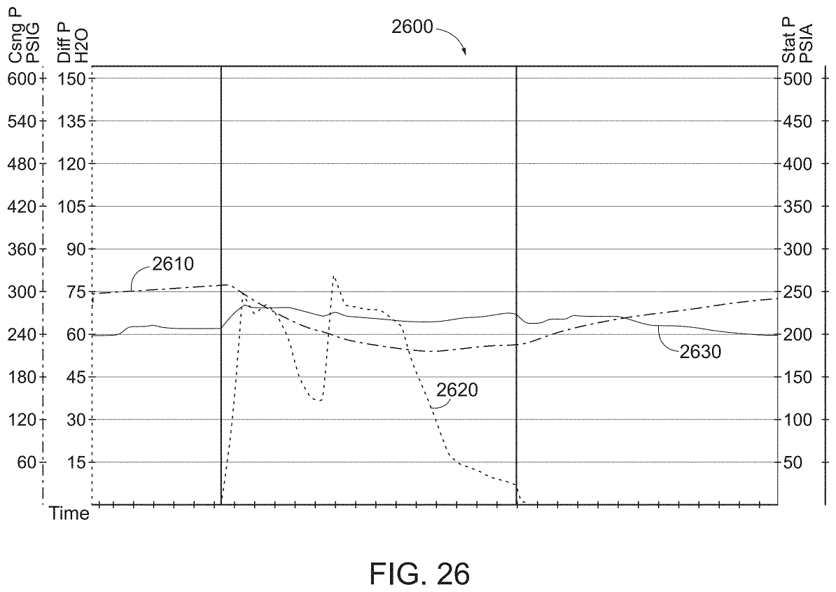

As shown in FIG. 25, a master host PC 2560 is in wireless communication via a data radio 2552 in a round robin fashion via communications towers 2540, 2550 and radio repeaters 2542 with a plurality of RTUs 2520, 2524, 2528 each connected to a data radio 2522, 2526, 2530. The host PC 2560 is programmed to periodically scan each RTU 2520, 2524, 2528 to update the three-minute trending files. It also updates the operating conditions of artificial lift equipment such as a beam pump and checks the status of valve positions, pumping unit on-off, and tank level positions. The host PC 2560 is a programmable data processing system with extensive memory and mathematical functions, allowing the device to communicate with a plurality of RTUs, remote PCs, and numerous data processing and data or graphical display devices. A critical function of the host PC 2560 is to convert the three-minute trending data files transferred from the RTU to analytical-quality data trend profiles can be displayed on a scalable time domain (zoom-in, zoom-out) from one-hour to one-year or longer.

Most oil producers ignore gas measurement because of the minute amount of gas by-product. The majority of the recently drilled, fractured, oil-shale wells, shown in FIG. 24 contain commercial amounts of both oil and gas so that three-phase measurement of oil, gas, and water is necessary for allocation or custody transfer as well as for accounting and reporting purposes. As shown in FIG. 23, most liquid-loaded gas wells are equipped with a flow control system to cycle the plunger lift equipment, while the wellhead is equipped with tubing pressure (TP) and casing pressure (CP) measurement devices that provide downhole information and liquid-loading conditions.

Irreconcilable Audit Trail of Hourly Averaged P, DP, and T

It is well recognized in the oil and gas industry that the hourly averaged data of the basic gas parameters of P, DP, and That have been accepted by AGA, API, and BLM as standard for audit trail are actually irreconcilable. The re-integrated or re-calculated results of the average hourly data of the primary parameters P, DP, and Tas reported by an offsite EFM have been proven to have an error of 3 percent to more than 30 percent when compared to the calculated results of the onsite EFM that provides the hourly average of P, DP, and T as audit trail.

Because gas volume is calculated from the equation,

Q=C′\sqrt{P×DP},

the total volume for a period is the sum of every second of the calculated volume for that period, hourly or daily. If the one-second readings of P and DP for a period of time are averaged, the calculated volume of the averaged P and DP for the period produces a different result when compared to the summation or integration of the volume calculated every second.

### EXAMPLE 1

Example 1 shows mathematically how hourly averaged data of P, DP and T do not provide reconcilable audit trail.

| | Given | Volume Calculation |
|---|---|---|
| First Hour | P = 100 psi | VolQ₁ = 150 × \sqrt{100 × 70} = 12,549.9 cf |
| | DP = 70″ | |
| | C′ = 150 | |
| | Flow is steady | |
| Second Hour | P = 100 psi | VolQ₂ = 150 × \sqrt{100 × 40} = 9,486.8 cf |
| | DP = 40″ | |
| | C′ = 150 | |
| | Flow is steady | |
| Two Hour | | Q₁ + Q₂ = 22,036.7 cf |
| Total Volume | | |
| Average DP for Two Hours | $\frac{70 + 40}{2} = 55$ | |
| Two Hours | | 2 × 150 × \sqrt{100 × 55} = 22,248.6 cf |
| Flow | | |

The error is 211.9 cf or 1%.

### EXAMPLE 2

Example 2 shows that averaging any positive number into the no-flow period (DP=0) introduces a large error in flow calculation.

| | Given | Volume Calculation |
|---|---|---|
| Well Flow for | P = 100 psi | VolQ = 150 × \sqrt{1100 × 1} = 1500 cf |
| 1 hour | DP = 1″ | |
| | C′ = 150 | |
| Well Shut Down | DP = 0″ | |
| for next 3 hours | | |
| | Averaged DP for | VolQ = 4 × 150 × \sqrt{100 × 0.25} = |
| | 4 hours = 0.25″ | 3000 cf |

The error is 100%. Based on the above calculated examples, the average hourly data of P, DP, and T, as reported by the common on-site EFM is not reconcilable.

DP Transducer Error (Zero-Shift) Results in Significant Gas Volume Calculation Error

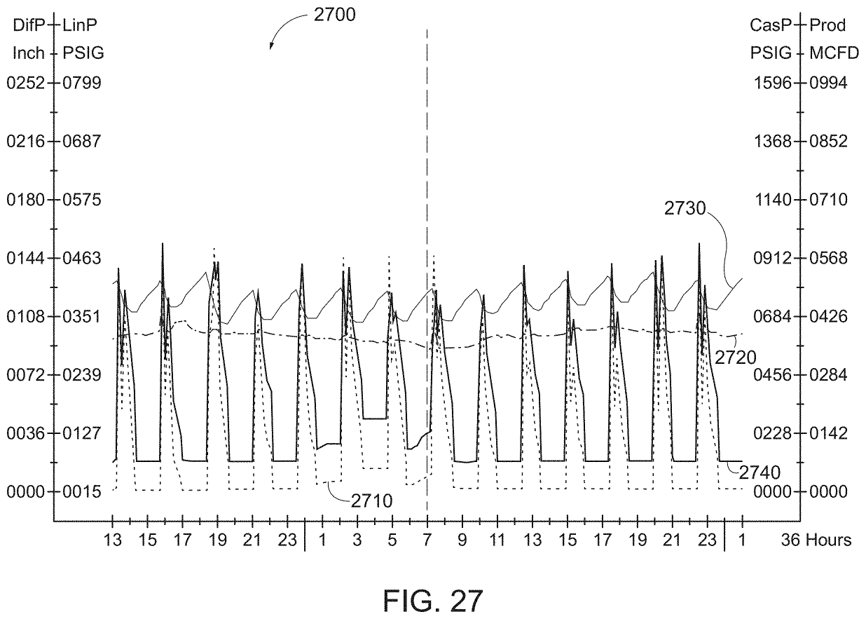

It is commonly recognized by the oil and gas industry that calibrated DP transducers (discrete or smart-multivariable) can randomly generate a positive value of DP when the well is shut-in or in a no-flow condition. This transducer error, known as zero-shift is a common occurrence. The trend date 2700 in FIG. 27 shows that significant amounts of flow volume 2740 were calculated by the EFM during a shut-in period when the DP transducer yields a positive value 2710. The trend data 2700 also includes line pressure 2720 and casing pressure 2730.

### EXAMPLE 3

Example 3 shows the effect of zero-shift, which results in falsely inflated gas volumes.

| | Given | Volume Calculation |
|---|---|---|
| The well is shut down in | P = 100 psi | VolQ = 24 × 150 × \sqrt{1 x 100} = |
| DP zero shift = 1″ | DP = 1″ | 36,000 cf |
| | C′ = 150 | |
| | Q = 24 hours | |

To compensate for the zero-shift problem that can significantly benefit the seller, the state-of-the-art EFM provides an option for the user to key in a zero-cutoff value. For example, entering a 1″ zero-cutoff value will cause the EFM to stop flow calculation when DP falls below 1″ if the transducer is expected to induce a potential zero-shift of no more than 1″. However, doing so would potentially shortchange the seller because many gas wells flow below 1″ DP. This situation can easily happen if the orifice plate size is incorrectly sized and/or if the liquid-loaded well is improperly controlled.

### EXAMPLE 4

Example 4 shows the detrimental shortfall to the seller when zero cut-off is applied.

| | Given | Volume Calculation |
|---|---|---|
| 24 hour | P = 100 psi | VolQ = 24 × 150 × \sqrt{0.5 × 100} = 24,455.8 cf |
| period | DP = 0.5″ | |
| | C′ = 150 | |
| | Q = 24 hours | |

Thus, it can be concluded that the current method of providing zero-cutoff input does not offer a fair solution to the DP transducer's zero-shift problem.

Sizing the Orifice Plate to Achieve Accurate Measurement

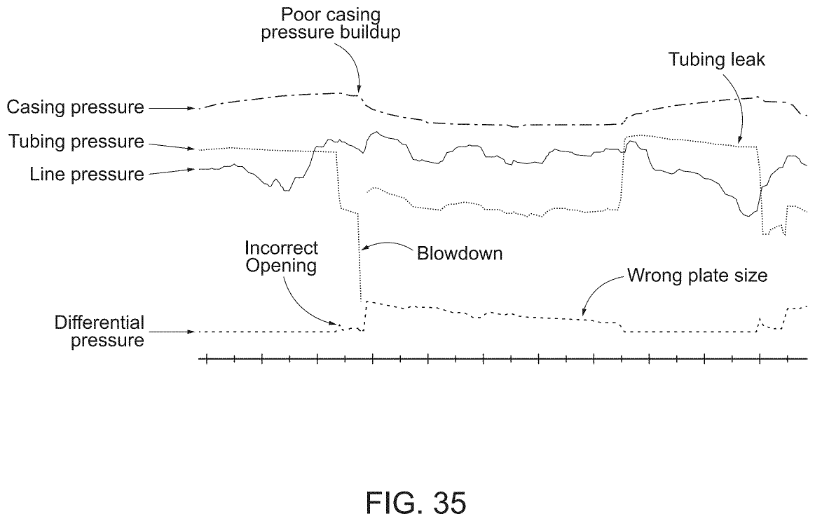

For a given orifice plate size the measurable ranges of the orifice meter are limited to a 3 to 1 turn down ratio. If the high end of measurable flow is limited to 3 million cubic feet per day (MMCFD), its low limit is 1 MMCFD. As publicized by AGA, the measurable ranges are limited between 100″ DP on the high end and 10″ DP on the low end. These limited ranges pose a challenge to proper sizing of the orifice plate. Particularly for a liquid-loaded gas well that requires intermittent cycling of the well to unload liquid, the conventional EFM, providing averaged hourly and daily data, does not provide any help to correctly size the orifice meter. Therefore, significant measurement slippage and income losses to either the seller or the producer can occur. FIG. 35 shows the effect of improper sizing of the orifice plate that barely registers any DP measurement, resulting in a significant measurement slippage.

Ineffective Flow Control

The narrow ranges (3 to 1 turn-down ratio) of the orifice meter are conducive to meter over- and under-ranging, leading to common measurement slippage. It is well recognized in the oil and gas industry that measurement slippage of more than 3 percent is a common measurement problem in gas custody transfer practice. Without high resolution analytical quality data, measurement slippage is not recognizable, and effective flow control within measurable ranges is not possible without one-second data logging.

Shortcomings of Current EFM Technology

To summarize, the conventional EFM has the following shortcomings:
The hourly average data of the primary parameters of P, DP, and T, for audit trail are not reconcilable.
It does not offer a solution or correction for transducer zero-shifting.
It does not provide data to allow proper sizing of the orifice plate.
It does not offer flow control of the produced gas.

Several example of objectives of the technology disclosed herein are to achieve the following:
Provide a high resolution trending data logger, efficient data transferring technique, and analytical quality trend data plotting with variable time-domains of hourly, daily, monthly, and annually.
Provide a reconcilable audit trail of P, DP, and T.
Provide a fair resolution to the transducer's zero-shifting problem.
Provide analytical quality trending data to facilitate proper sizing of the orifice plate.
Provide flow control of the produced gas to be within measurable ranges of the orifice meter with one-second precision action.

### EXAMPLE 5

Example 5 shows the air time needed to transfer 24 hours of one-second analog data using the current conventional radio system.

| Given | Data Calculation |
|---|---|
| 24 hours of one-second | 24 hours × 3600 seconds × 16 bits = |
| data | 1,382,400 bits |
| One second data point = 16 | |
| bits | |

There are 5 channels of analog data that include TP, CP, P, DP, and T. The calculated gas flow Q is a double precision number that requires 4 bytes or 32 bits per one second data point or an equivalent of 2 analog channels. Therefore, the total number of analog channels to be transmitted is 7 channels or a total of 9,767,800 bits.

7×1,382400=9,767,800 bits

At 96,000 BAUD, it will take 101.75 seconds or 1.75 minutes.

$$\frac{9 \text{,} 767 \text{,} 800}{96 \text{,} 000} = 101.75 seconds$$

If the communication system is 100% reliable, and the PC host polls the RTUs continuously for one hour, the maximum number of RTUs can be polled are 34.28.

$$\frac{60}{1.75} = 34.28 RTUs$$

The majority of oil and gas fields have hundreds or thousands of wells or RTUs. Most operators want the host to scan the RTU at least once an hour in order to maintain proper surveillance of the operating conditions, such as high-tank level detection, pumping unit down, or dump valve stuck open. Therefore, it would be impossible and impractical to transmit one-second data wirelessly using the conventional radio system with a data exchange rate of 9,600 BAUD.

By simply averaging the one-second data file to 1.5 minutes, the file would be effectively compressed 90 times and reduce traffic congestion of the air waves since the state-of-the-art radio system is capable of a 96,000 BAUD data transfer rate. Doing so would increase the number of RTUs to be scanned in one hour by 90 times or 3,085 RTUs.

90×34.28=3,085 RTUs

The above data averaging technique may be used as a data compression technique in order to reduce the air-time or data transmission time to transfer voluminous data files using conventional wireless radio system or land line.

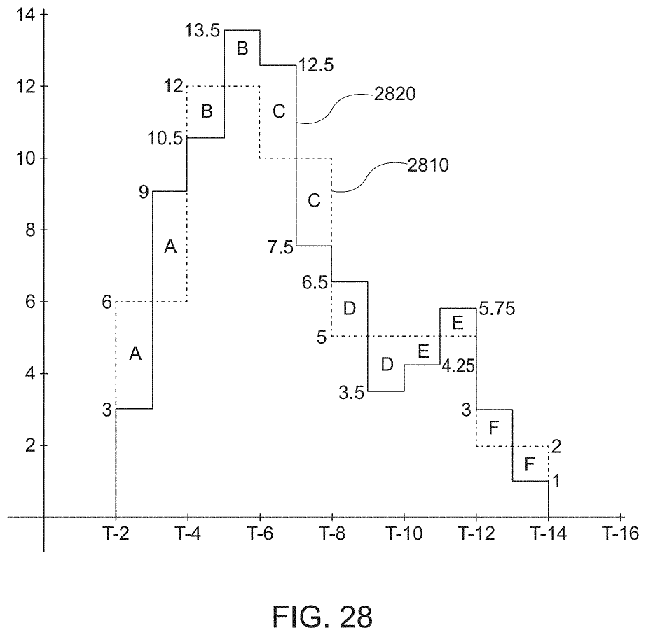

FIG. 28 shows a method of using a process called herein binary redistribution (BR), similar to the trend data expansion process of FIG. 3, to transform a series of trend data with one data point per unit time to a series of two data points with half of the unit time. In the example case, one unit of time represents three minutes and the BR transformation converts each three-minute data point to two data points with a 1.5-minute time interval. The two 1.5-minute data points are trigonometrically adjusted to conform with the slope of the data point to the front and the next one.

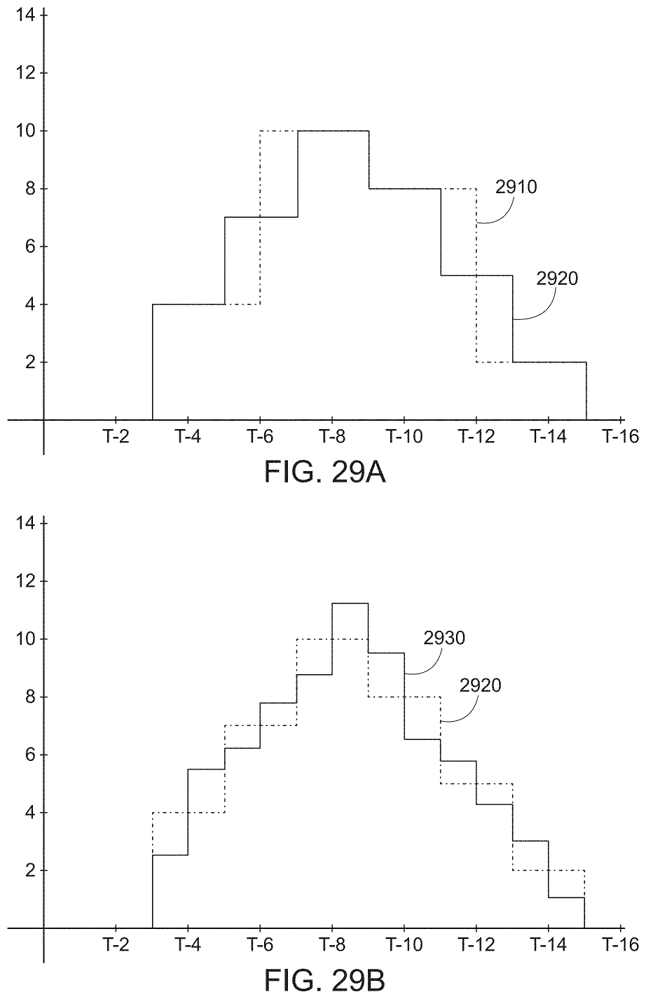

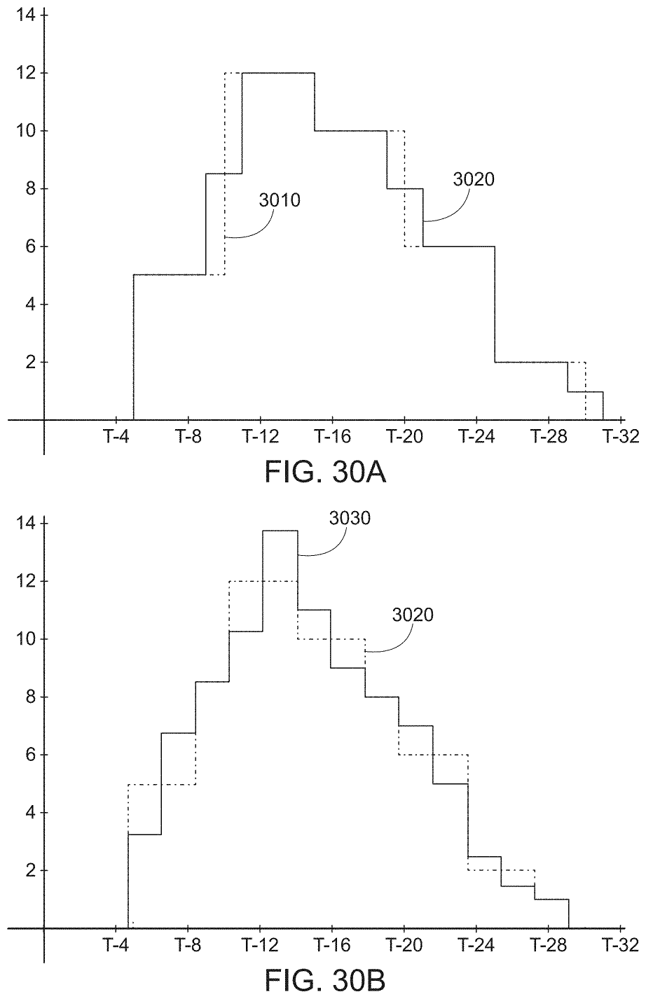

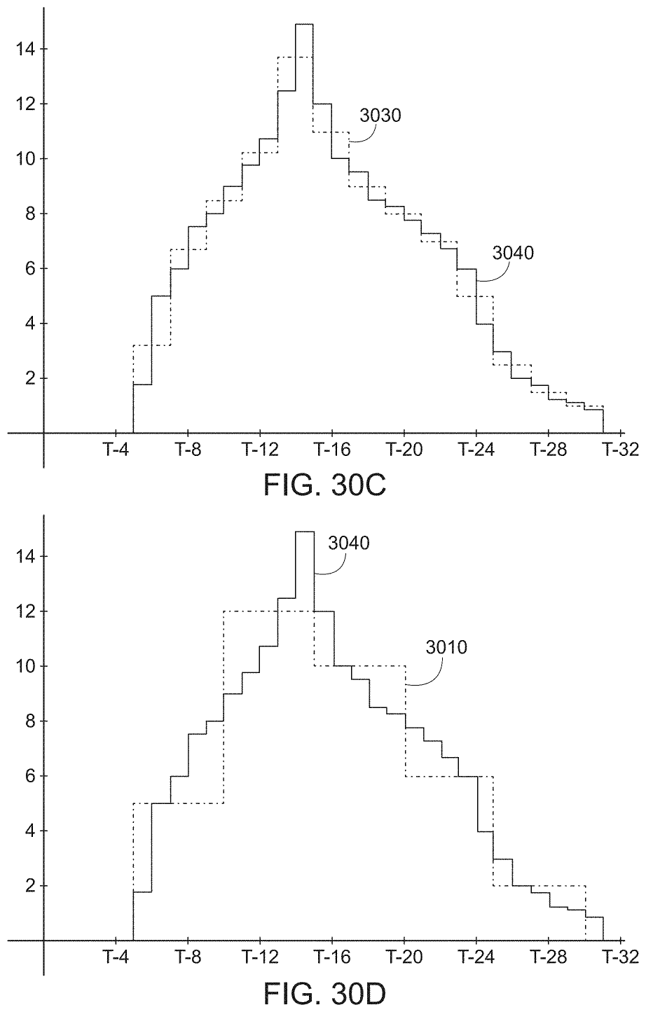

As shown in FIG. 28, the two 1.5 minutes with the value of 6, 6 are adjusted to 3, 9 to form a continuous series of trend data that progresses seamlessly from 0 to 3 to 9 and 12. FIGS. 29A and 29B graphically illustrate the conversion of one 3-minute data point to three 1-minute data points that are seamlessly interconnected with adjacent data points using the BR technique. Similarly, FIGS. 30A-30D illustrate the three-step process of converting a series of 5-minute trend data to a series of 1-minute trend data. FIG. 30D compares the expanded trend data set 3040 to the original trend data set 3010 of FIG. 30A. Intermediate trend data sets 3020, 3030 are shown in FIGS. 30B and 30C. Note that 180 seconds contain primary root multipliers of 2×2×3×3×5. Therefore, to transform a series of 3-minute trend data to 1-second trend data requires successive BR transformations of 2×2×3×3×5.

Recalculation of One-Second Data File for DP

Since flow-rate Q is calculated according to the gas flow formula Q=C′\sqrt{P×DP} note that s Q, P, or DP can be recalculated if the other two variables are given or known. In this case, if the host receives the one-second data files of Q and P variables, the one-second data file of DP can be recalculated using the gas flow equation of Q=C′\sqrt{P×DP}. Therefore, to solve for DP from the above equation, use

$$DP = \frac{{Q}^{2}}{( {C}^{2} \times P )}$$

It is thus part of a data compression technique to transmit only the three variables P, T, and Q in lieu of four variables P, DP, T, and Q that are normally transmitted to the host PC required by AGA, API, and BLM for audit trail and custody transfer data reporting from a remote EFM.

Using the above scheme will save about 25 percent of the data transmission time when the gas flow data are transmitted by mean of a wired or wireless system. This invention along with the aforementioned technique of trend data compression and de-compression can result in an overall data compression ratio of better than 100 to 1. The state-of-the-art wireless system is capable of 100 KBAUD (100,000 bits per second). This data compression technique is equivalent to a data transfer rate of 10 MBAUD or 10 million bits per second.

Plotting the One-Second Data Trending Files

The one-second data files are plotted on the monitor screen with a variable number of pixels. If the full horizontal screen of the monitor has 1,200 pixels, to plot or display one hour or 3,600 seconds of the one-second data trending file is straightforward. Each pixel will be the averaging of 3 one-second data points (3,600/1200=3 seconds per pixel).

Example 6 shows mathematically that with a monitor screen of 1,080 pixels resolution, the number of data points of one hour and the number of pixels ratio is not a real number, but is fractional.

| Given | Data Calculation | Result |
|---|---|---|
| One hour of one-second data points per 1080 | $\frac{3600}{1080} = \frac{360}{108} = \frac{2 \times 2 \times 2 \times 3 \times 3 \times 5}{2 \times 2 \times 3 \times 3 \times 3} = \frac{10}{3}$ | 10 one-second data points per every 3 pixels |
| pixels | | |

Each pixel's time period will be represented by 3 and ⅓ of one-second data points.

The simple and common solution to plotting one-second data on a monitor screen with 1080 pixels is to go to the next real number of 4 one-second data points per pixel. However, doing so will take only 3,600/4, or 900 pixels to display one-hour of one-second trend data, leaving 180 pixels or 17% of the screen blank.

As Example 6 shows, the ratio of data points per pixels equals 10/3, or every one-second data point duplicated three times will yield the ⅓-second data file. That is, each data point is represented by a ⅓-second time span. Averaging 10 data points of the 3/10-second data file will convert the ⅓-second data file back to a 10/3-second data file where each pixel occupies a time span of 10/3 seconds.

### EXAMPLE 7

Example 7 illustrates a mathematical technique to linearly expand and average the one-second data trend to fill the monitor screen with any resolution.

| | |
|---|---|
| Given the following series | 6, 8, 10, 15, 12, 20, 2 |
| of 7 one-second data | |
| points: | |
| Duplicating each one | 6, 6, 6, 8, 8, 8, 10, 10, 10, 15, 15, 15, 12, 12, 12, 20, 20, |
| second data point 3 times | 20, 2, 2, 2 |
| creates 21 data points with | |
| 1/3 second time intervals: | |
| Averaging 10 data points | First pixel = (6 + 6 + 6 + 8 + 8 + 8 + 10 + 10 + 10 + 15)/10 = 8.7 |
| with 1/3 second time | Second pixel = (15 + 15 + 12 + 12 + 12 + 20 + 20 + 20 + 2 + 2)/10 = |
| intervals results in the | 13 |
| value of a pixel with a 10/3 | 1,080 pixels × 10/3 seconds per pixel = 3,600 seconds |
| seconds time interval: | |

Based on the above, the process to convert a one-second data trending file to fit the display screen of a desirable timeframe that has a given pixel resolution can be defined as follows:

| | | |
|---|---|---|
| 1 | Determine | the ratio of the display time in seconds, X vs. the screen |
| | | resolution in number of pixels, Y. |
| | | The ratio equals X/Y per Example 6 above X/Y = |
| | | 3,600/1080. |
| 2 | Reduce | 3,600/1080 into the lowest root of nominator/denominator, |
| | | which is 10/3. |
| 3 | Duplicate | each one-second data point by the denominator, |
| | | which is 3. |
| 4 | Average | the above Step 3 of expanded data points by the |
| | | nominator, which is 10. |

The above plotting of one-second data trend files on a one-hour timeframe provides analytical quality of one full cycle for a liquid-loaded gas well that is controlled by a high speed intermittent controller to unload the liquid built up 24 times a day.

### EXAMPLE 8

In order to produce a zoom-in effect to display more detail of the trend by reducing the timeframe to ½ hour, Step 4 of Example 7 that expands the average data points of ⅓ seconds, is reduced to a 5. Therefore, each pixel will have a reduced timeframe to 5/3 seconds, and each pixel has the value as follows.

| | |
|---|---|
| First pixel = | (6 + 6 + 6 + 8 + 8)/5 = 6.8 |
| Second pixel = | (8 + 10 + 10 + 10 + 15)/5 = 10.6 |
| Third pixel = | (15 + 15 + 12 + 12 + 12)/5 = 13.2 |
| Fourth pixel = | (20 + 20 + 20 + 2 + 2)/5 = 12.8 |

Similarly, to expand our zoom-out timeframe to two hours, the averaged expansion factor of Step 4 of Example 7 is increased to 20. Therefore, each pixel will have a timeframe or time interval of 20/3 seconds, and each pixel will have a value as follows:

| | |
|---|---|
| First | (6 + 6 + 6 + 8 + 8 + 8 + 10 + 10 + 10 + 15 + 15 + 15 + 12 + 12 + 12 + 20 + 20 + 20 + 2 + 2)/20 = |
| pixel = | 10.85 |

Based on the above methodologies detailed in Example 6 and Example 7, software can be written to produce zoom-in and zoom-out effects of displaying the one-second data trend files in any time scale. Doing so will provide analytical quality data for long-term reservoir analysis to short-term analysis of the performance of production facilities and artificial liquid-lift equipment as well as secondary or tertiary injection systems.

Filtering Technique for ‘Paint-Brush’ Trend Display

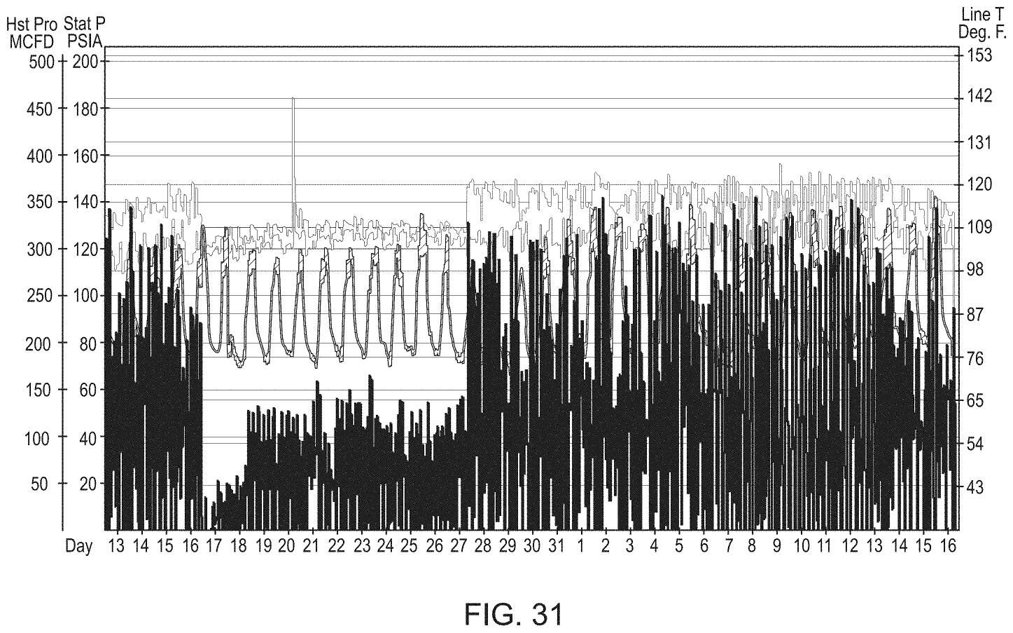

FIG. 31 shows a trend plotting with a ‘paint-brush’ effect, a condition that occurs when the time scale compresses the display of highly fluctuated trend data that obscures the analytical quality of the trend. A mathematical process, called herein “Integrated Trigonometric Redistribution” (ITR) is disclosed to effectively filter out the obscured or ‘paint-brush’ trend data.

The filtering technique employs stepwise averaging of the trend data based on the root multiplier factors of the horizontal pixel numbers. If the horizontal display has 1080 pixels, its root multiplying factors are 2×2×2×3×3×3×5=1080.

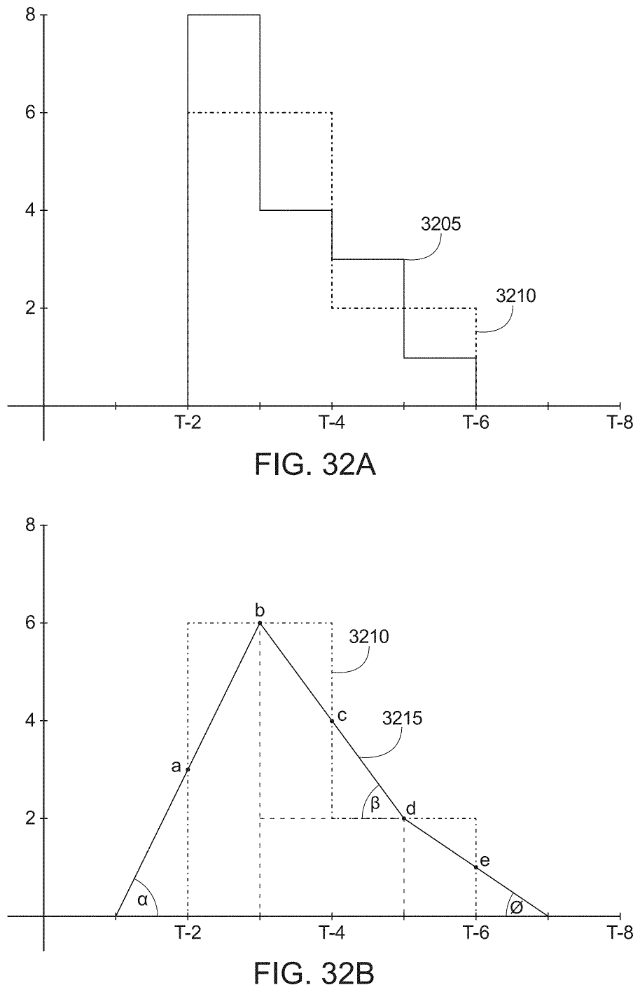

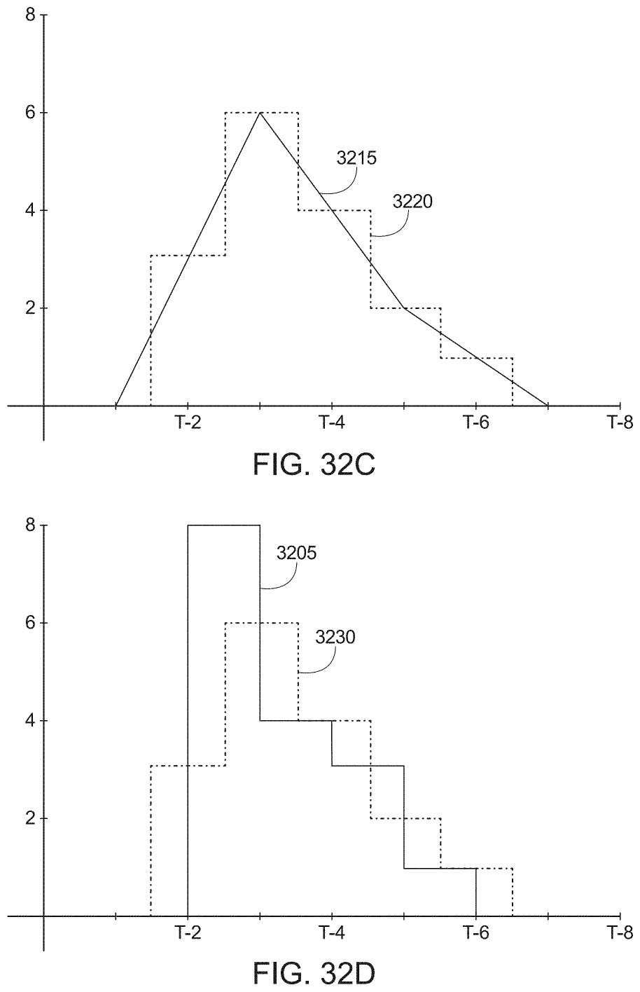

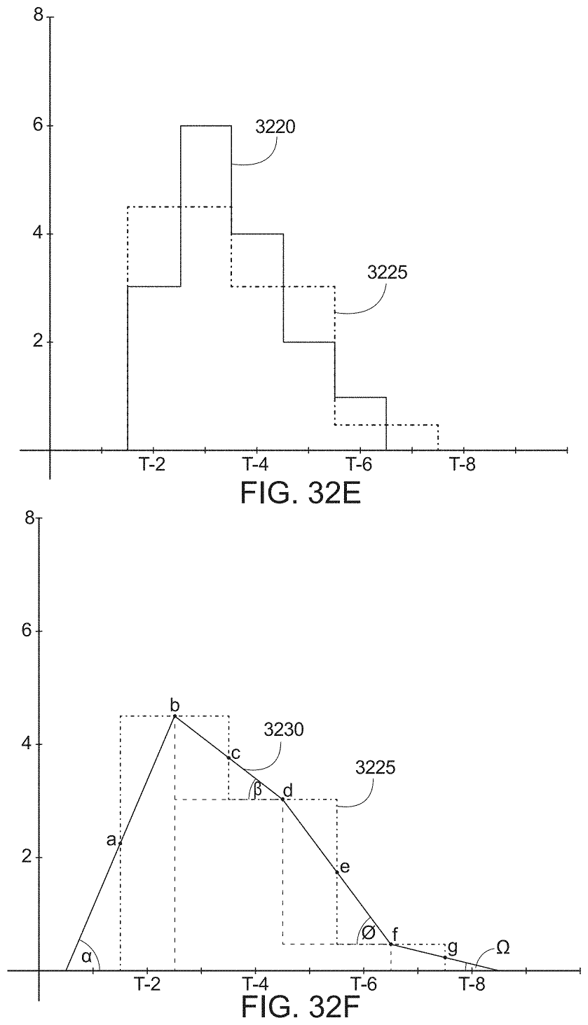

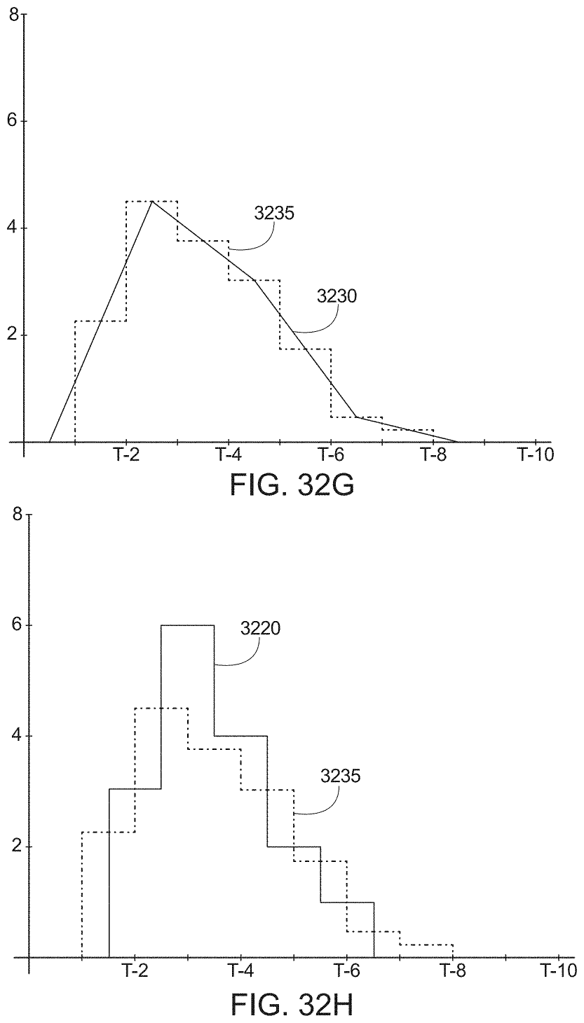

The first step of filtering, using the root multiplier of 2 is the averaging of two data points and replacing the two data points with the averaged results as illustrated in 32A-32D. The results are series of pairs of data points with the same value. The next step is to redistribute each pair of data to form a tangential slope based on the two adjacent data points. FIGS. 32E-321 illustrate a successive filtering step with another root multiplier of 2.

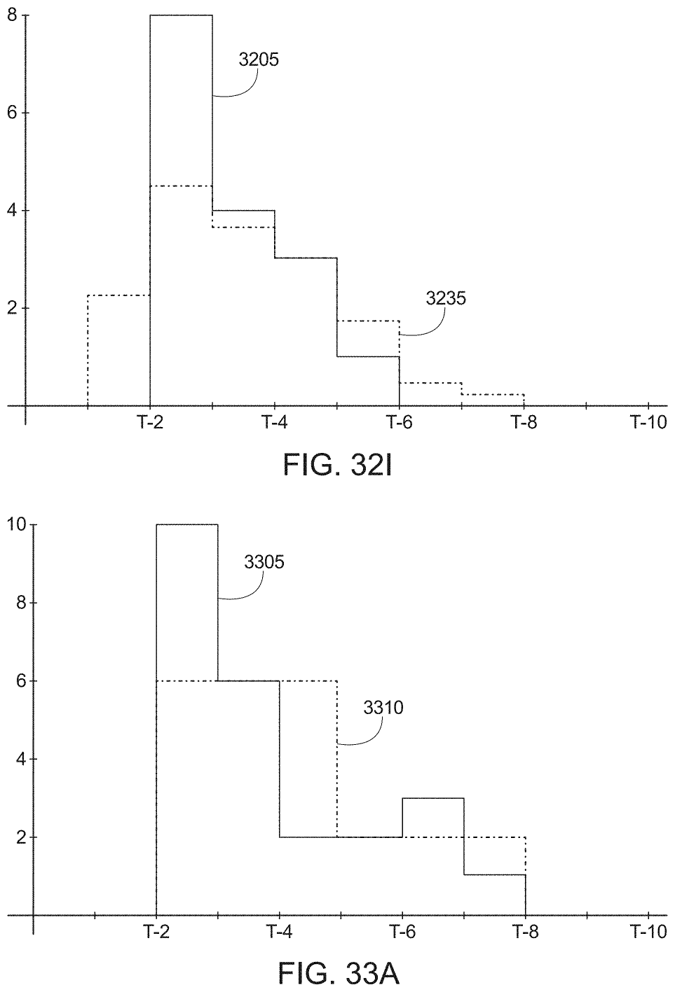

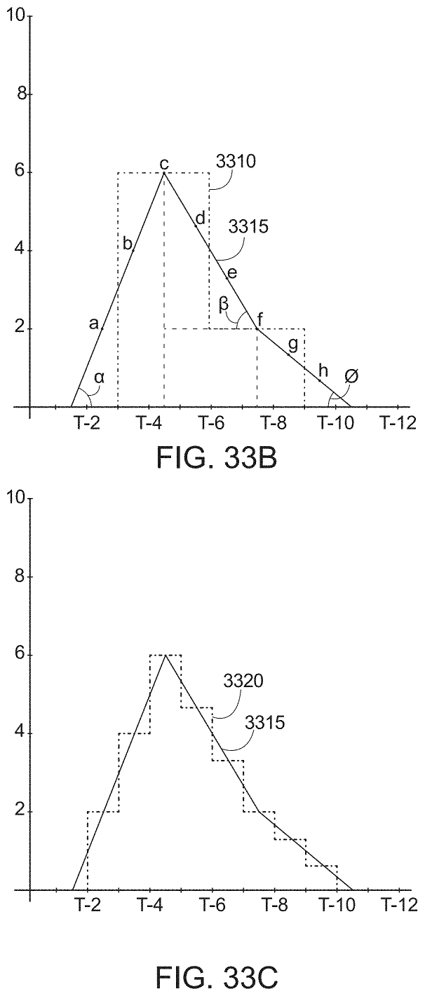

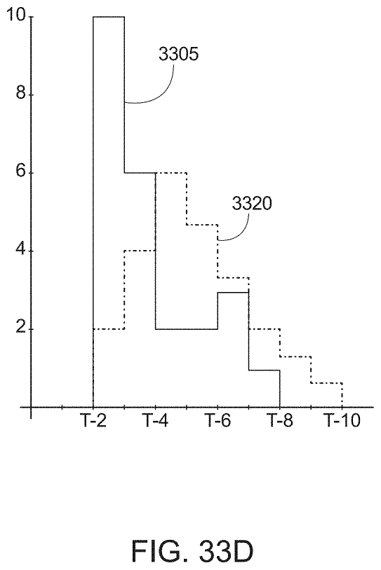

FIGS. 33A-33D illustrate steps of filtering with a root multiplier of 3 by averaging every 3 data points and replacing the same with the averaged result. FIGS. 32B and 32F illustrate the trigonometric redistribution of similar sets of data to form seamless slopes connecting the adjacent data points.

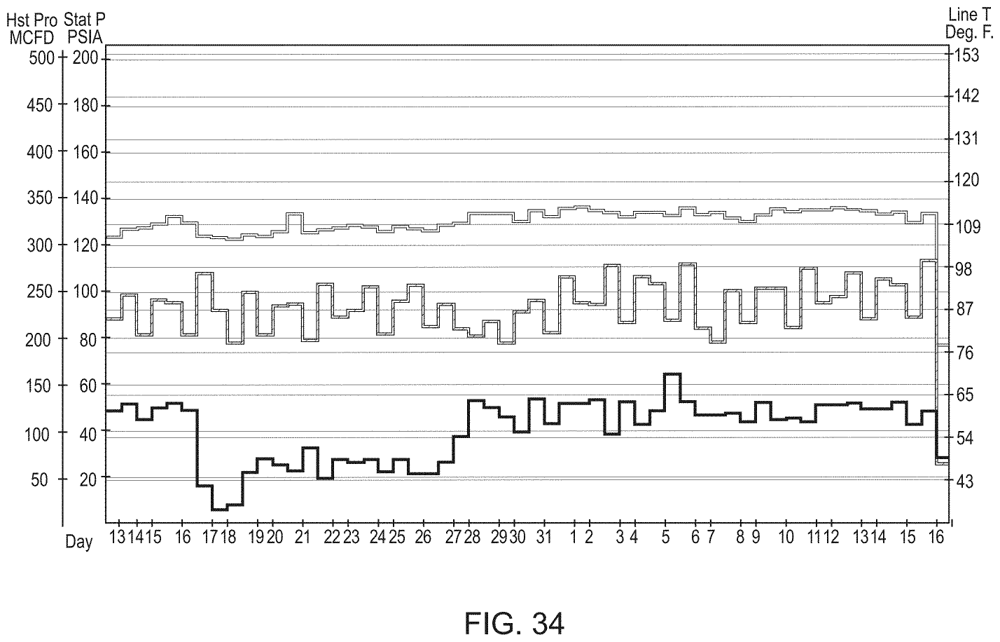

Similar ITR filtering processes can be applied to other odd multiplier root factors, such as 5, 7, 11, etc. For a screen with 1080 pixels or data points, the root multipliers of 1080 equal 2×2×2×2×3×3×5. This allows a filtering process using the 2 root multiplying factor four times, the 3 root multiplying factor twice, and the 5 root multiplying factor once. FIG. 34 show results of the successively filtered trends.

Operate, Produce, Control, and Measure with One-Second Data Trending

As discussed above, it would be impractical to transfer one-second trending data using the current wireless technology without the invented data compression and expansion techniques of Example 5. Without the techniques and mathematical modules of Examples 6 and 7 to adjust the one-second data files to fit any screen resolutions with zoom-in and zoom-out, the utilization of the one-second data trend would be limited.

FIG. 35 shows the diagnostic results of the (12 hours) zoom-in analytical quality trend-profiles of the one-second resolution data. The trend profiles show that control strategy of the plunger controller is ineffective, causing unnecessary well blowdown and preventing efficient casing pressure build-up. It also shows a tubing leak that accelerates liquid build-up and reduces production. The low DP profile, which averages less than 5″ when the well is flowing, is out of AGA's and API's specifications for flow measurement. It is an obvious case of using the wrong orifice plate size.

With analytical quality data, an effective control algorithm can be implemented, a tubing leak can be repaired timely, and an orifice plate can be correctly sized so that flow can be maintained at about 70″ DP as recommended by AGA and API for best accuracy.

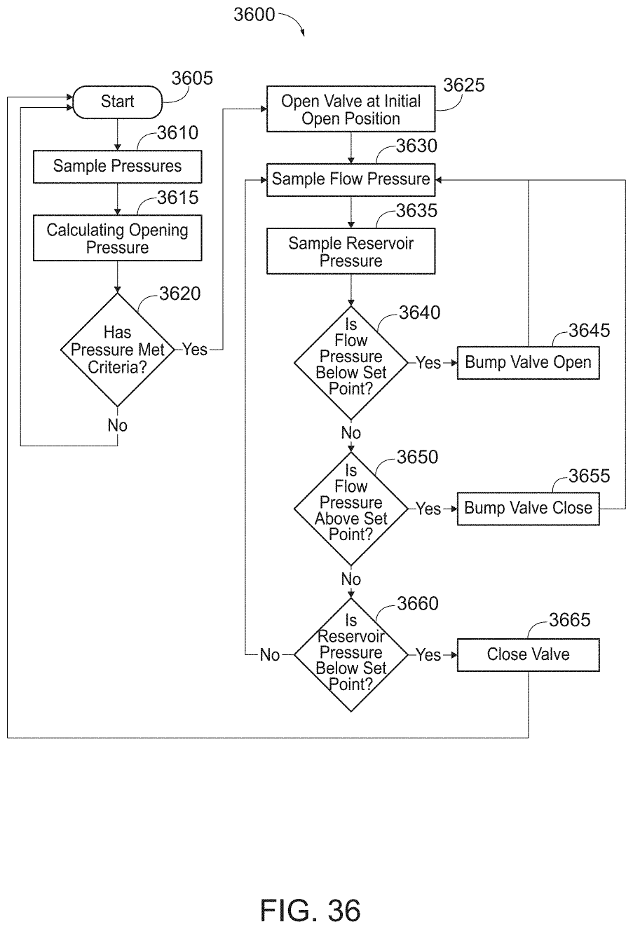

Effective flow control within measurable ranges based on one-second data acquisition of DP by the one-second data logger can be programmed into the SCADA or RTU according to the flow control scheme 3600 shown in FIG. 36. The flow control process begins 2605 by sampling the reservoir pressure at the wellhead as indicated in step 3610. A desired opening pressure is calculated by the host PC and provided to the RTUs or pump controllers as indicated in step 3620. If the calculated opening pressure is not met, the process returns to step 3605. If the calculated opening pressure is met, the flow valve is opened at an initial open position as indicated in step 3625. The flow pressure is then sampled as indicated in step 3630. The reservoir pressure is also sampled as indicated in step 3635. The flow pressure measurements are then compared to set point. If the flow pressure is below a set point as determined in step 3640, a bump valve is opened to a greater degree to increase flow as indicated in step 3645 and the process flow returns to step 3630 to sample the flow pressure again. If the flow pressure is above a set point as determined in step 3650, a bump valve is partially closed to a degree to decrease flow as indicated in step 3655 and the process flow returns to step 3630 to sample the flow pressure again. If the flow pressure is within the parameter of the set point, the process determines if the reservoir pressure is below a separate set point as indicated in step 3660. If the reservoir pressure is above the set point, the process returns to measuring the flow pressure in step 3630 and reservoir pressure in step 3635 to maintain the desired flow. If the reservoir pressure is below the set point, the flow valve is closed completely as indicated at step 3665 and the process returns to the beginning to sample the reservoir pressure again. A motorized choke as shown in FIG. 24 can be installed to complete the measurable flow control system that also includes the one-second data logger and the control algorithm as shown in the flow chart in FIG. 36.

Reconcilable Audit Trail

Examples 1 and 2 above demonstrated that the current accepted hourly averaged data of P, DP, and T reported by the onsite EFM or RTU are not reconcilable because the recalculated results of flow-volume Q using the hourly averaged P, DP, and T by an offsite EFM do not match the calculated volume reported by the onsite EFM. See below for a comparison of flow calculated results of hourly and one-second data.

| | Steady Flow | Variable Flow | Intermittent Flow |
|---|---|---|---|
| | Characteristic | Characteristic | Characteristic |
| % deviation | 0.1% | 3% + | 30% + |
| average | | | |
| hourly date | | | |
| % deviation | 0.1% | 0.1% | 0.1% |
| one-second | | | |
| date | | | |

Resolving the DP Zero-Shift Problem with One-Second Data

Example 3 and Example 4 illustrate that the current method of arbitrarily keying in a zero cut-off value does not fairly solve the DP transducer zero shifting problem. FIG. 27 clearly shows both the one-second data of DP 2710 and flow volume 2740. The zero-shift values of every second of DP 2710 and flow volume Q 2740 are clearly recorded during the shut-in period. Correcting the zero-shift problem is as simple as removing the known one-second zero-shift values from the one second values of the DP data file and the corrected Q volume can be reintegrated.

Proper Sizing of the Orifice Plate with One-Second DP Data Trend Profiles

AGA and API specify that to achieve accurate results for flow calculation of the orifice meter, DP must be maintained at about 70″. This can be done by reading the value of DP with a direct measuring device if the flow rates can be controlled at a constant rate. Unfortunately, the majority of gas wells are not capable of maintaining steady flow. Much worse, wells with a liquid-loading problem require periodic shut-in of the well to rebuild adequate bottom-hole pressure to unload liquid build-up. Therefore, a visual inspection of the analytical quality trending profile of DP provides a practical way to determine the mean value of DP during the flow period for proper sizing of the orifice plate.

Flow Control with One-Second Data to Improve Measurement Accuracy and Optimize Production

Using a common intermittent controller operating in conjunction with a plunger has become a popular liquid-lift system for gas wells with liquid-load problems. Negative effects of the plunger lift controller are over-ranging of the flow meter and the wasting of reservoir pressure on the initial opening cycle.

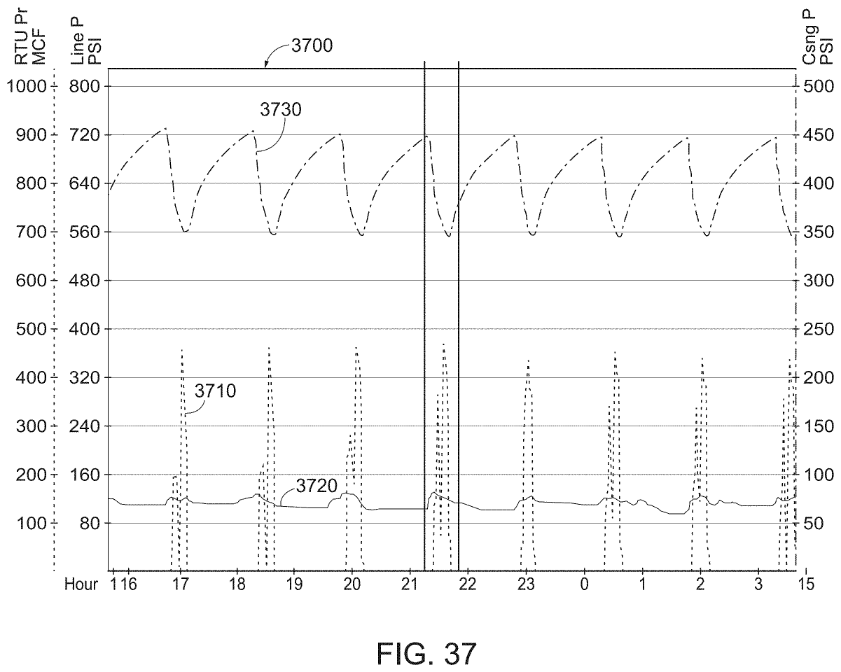

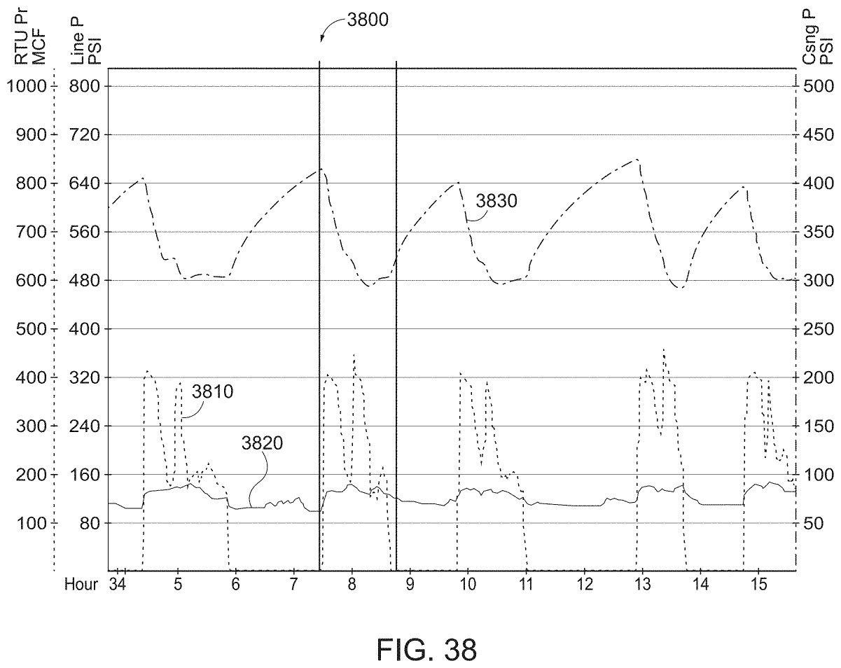

With one-second data logging, a control algorithm can be implemented to arrest the DP from over-ranging and regulate the flow at 70″. FIGS. 37 and 38 together show trend results of a liquid-loaded well using an intermittent controller with flow control and a controller that fully opens the well with no flow control. The test period with flow control shows an average daily production 3810 of 130 MCFD while the test period with no-flow control shows an average production 3710 of 50 MCFD.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, processes, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples, and data and the attached appendix provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method in a computer system for expanding an initial set of trend data values, the method comprising
generating via a particularly configured microprocessor an expanded set of trend data values interpolating trend data values in the initial set of trend data values by
receiving an input data stream of the initial set of trend data values;
dividing each initial trend data value of the initial set of trend data values into two extrapolated values, wherein
a first extrapolated value is less than its corresponding initial trend data value; and
a second extrapolated value is greater than its corresponding initial trend data value; and
dividing a time period of each initial trend data value in half;
associating the first extrapolated value with a first half of the time period;
associating the second extrapolated value with a second half of the time period; and
outputting as an output data stream a series of the first and second extrapolated values each over half of the time period in replacement of each corresponding initial trend data value to create the expanded set of trend values.

2. The method of claim 1, wherein both of the first and second extrapolated values are equally spaced from their initial trend data value.

3. The method of claim 1, wherein if a first distance between a prior extrapolated value and an adjacent initial trend data value is lesser in value than a second distance between the adjacent initial trend data value and a subsequent initial trend data value, then the first and second extrapolated values are adjusted to be half the first distance from the adjacent initial trend data value.

4. The method of claim 1, wherein if a first distance between a prior extrapolated value and an adjacent initial trend data value is greater in value than a second distance between the adjacent initial trend data value and a subsequent initial trend data value, then the first and second extrapolated values are adjusted to be half the second distance from the adjacent initial trend data value.

5. The method of claim 1, wherein the original set of trend data values is a set of compressed data values.

6. The method of claim 1 further comprising repeating the steps of claim 1 on the expanded set of trend data values by considering the expanded set of trend data values to be the initial set of trend values in order to iterate the method.

7. The method of claim 6, wherein iteration of the method results in an expanded set of trend data values forming a curve with analytical quality.

8. The method of claim 6 further comprising before beginning one of the iterations
dividing the time period of each initial data trend into a higher prime number of partitions rather than in half during the one of the iterations; and
averaging the data values of groups of the partitions over a subset of time periods of the partitions to reduce the number of the partitions to an even number of partitions.

9. The method of claim 1, wherein each of the initial trend data values is a pixel intensity value.

10. The method of claim 1, wherein each of the initial trend data values is a recorded data value from a transducer at a wellhead.
